(19) United States
(12) Patent Application Publication
(10) Pub. No.: US 2024/0259538 A1
(43) Pub. Date: Aug. 1, 2024

(54) ELECTRONIC APPARATUS AND CONTROLLING METHOD THEREOF

(71) Applicant: SAMSUNG ELECTRONICS CO., LTD., Suwon-si (KR)

(72) Inventors: Hyungchul Kim, Suwon-si (KR); Seunghyun Moon, Suwon-si (KR); Sungho Chae, Suwon-si (KR)

(73) Assignee: SAMSUNG ELECTRONICS CO., LTD., Suwon-si (KR)

(21) Appl. No.: 18/631,867

(22) Filed: Apr. 10, 2024

Related U.S. Application Data
(63) Continuation of application No. PCT/KR2022/013514, filed on Sep. 8, 2022.

(30) Foreign Application Priority Data
Nov. 5, 2021 (KR) 10-2021-0151157

(51) Int. Cl. H04N 9/31; G06T 7/70; G06V 20/50

(52) U.S. Cl. CPC H04N 9/3185; G06T 7/70; G06V 20/50; G06T 2200/24

(57) ABSTRACT

An electronic apparatus includes a projection unit, a sensor assembly; and a processor configured to: acquire state information including at least one of horizontal inclination information, vertical inclination information, or horizontal distortion information based on sensing data acquired through the sensor assembly, based on acquiring at least one of the horizontal inclination information or the vertical inclination information in the state information, perform a keystone function, based on acquiring the horizontal distortion information in the state information, perform a leveling function, and control the projection unit to output a projection image onto a projection surface.

### CROSS-REFERENCE TO RELATED APPLICATION(S)

This application is a continuation of International Application No. PCT/KR2022/013514, filed on Sep. 8, 2022, in the Korean Intellectual Property Receiving Office, which is based on and claims priority to Korean Patent Application No. 10-2021-0151157, filed on Nov. 5, 2021, in the Korean Intellectual Property Office, the disclosures of which are incorporated by reference herein in their entireties.

### BACKGROUND

### 1. Technical Field

The disclosure relates to an electronic apparatus and a controlling method thereof, and to an electronic apparatus that performs an image correction in consideration of the arrangement state of the electronic apparatus 100, and a controlling method thereof.

### 2. Description of Related Art

In case an electronic apparatus performing a projection function outputs a projection image, the electronic apparatus may ultimately output the projection image by correcting the projection image according to the arrangement of the electronic apparatus and the projection direction toward a projection surface.

Here, as a representative example of correcting an image, there may be a keystone correction. A keystone correction may mean an operation of correcting an image in a trapezoid form to a rectangular form. It may be decided whether a keystone correction is necessary according to a direction in which an electronic apparatus projects an image toward a projection surface. A function in which a keystone correction is performed automatically may be a keystone function.

However, a case in which a leveling function is needed other than a keystone correction may be generated. Leveling may mean an operation of rotating an image based on a direction facing a projection surface.

In case the electronic apparatus is correctly arranged toward a projection surface, a separate image correcting operation may not be needed, but in case a user directly arranges the electronic apparatus, it may be difficult to arrange the electronic apparatus in a correct location, and a fine error may be generated.

Also, in the case of performing only a keystone correction, a projection image may be output while being partially rotated in a situation in which a horizontal distortion was generated, and thus a projection image not appropriate for a user may be provided.

### SUMMARY

Provided is an electronic apparatus that performs a keystone function and a leveling function for correcting an image automatically in consideration of state information of the electronic apparatus, and a controlling method thereof.

Additional aspects will be set forth in part in the description which follows and, in part, will be apparent from the description, or may be learned by practice of the presented embodiment.

According to an aspect of an embodiment, an electronic apparatus may include a projection unit, a sensor assembly; and a processor configured to: acquire state information including at least one of horizontal inclination information, vertical inclination information, or horizontal distortion information based on sensing data acquired through the sensor assembly, based on acquiring at least one of the horizontal inclination information or the vertical inclination information in the state information, perform a keystone function, based on acquiring the horizontal distortion information in the state information, perform a leveling function, and control the projection unit to output a projection image onto a projection surface.

The processor may be further configured to: acquire information based on the projection surface, identify a size of a projection area in which the projection image is output and a size of the projection image based on the information based on the projection surface, and control the projection unit to output the projection image in the projection area based on the size of the projection image, where the information based on the projection surface includes: at least one of pattern information of the projection surface, color information of the projection surface, or distance information between the projection surface and the electronic apparatus.

The processor may be further configured to: based on identifying a predetermined object, control the projection unit to output the projection image depending on a location of the predetermined object.

The predetermined object may include a line object, and the processor may be further configured to: based on identifying the line object, control the projection unit such that the line object and an outer rim portion of the projection image are in parallel.

The predetermined object may include an edge object, and the processor may be further configured to: control the projection unit to output the projection image onto a first projection surface among a plurality of projection surfaces divided by the edge object.

The electronic apparatus may further include a camera, and the processor may be further configured to: based on acquiring vibration information greater than or equal to a threshold value based on the sensing data of the sensor assembly, acquire a captured image through the camera, and identify the predetermined object based on the captured image.

The processor may be further configured to: based on identifying a predetermined event, provide a user interface (UI) for providing at least one function of a rotation function of a projection image, a size change function of a projection image, or a location change function of a projection image.

The processor may be further configured to: based on acquiring movement information greater than or equal to a threshold value, and based on the sensing data of the sensor assembly, perform at least one of the keystone function or the leveling function.

The electronic apparatus may further include a communication interface configured to communicate with an external apparatus, and the processor may be further configured to: acquire location information of the external apparatus, and identify a projection area in which the projection image is output based on the location information of the external apparatus.

The processor may be further configured to: based on a change of the location information of the external apparatus, change the projection area in which the projection image is output.

According to an aspect of an embodiment, a method of controlling an electronic apparatus may include: acquiring state information including at least one of horizontal inclination information, vertical inclination information, or horizontal distortion information; based on acquiring at least one of the horizontal inclination information or the vertical inclination information in the state information, performing a keystone function; based on acquiring the horizontal distortion information in the state information, performing a leveling function; and outputting a projection image onto a projection surface.

The method may further include acquiring information based on the projection surface; identifying a size of a projection area in which the projection image is output and a size of the projection image based on the information based on the projection surface; and outputting the projection image in the projection area based on the size of the projection image, where the information based on the projection surface includes: at least one of pattern information of the projection surface, color information of the projection surface, or distance information between the projection surface and the electronic apparatus.

The method may further include: based on identifying a predetermined object, outputting the projection image depending on a location of the predetermined object.

The predetermined object may include a line object, and the outputting the projection image may include: based on identifying the line object, outputting the projection image such that the line object and an outer rim of the projection image are in parallel.

The predetermined object may include an edge object, and the outputting the projection image may include: outputting the projection image onto one projection surface among a plurality of projection surfaces divided by the edge object.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view illustrating the exterior of the electronic apparatus according to an embodiment of the disclosure;

FIG. 2 is a block diagram illustrating a configuration of the electronic apparatus according to an embodiment of the disclosure;

FIG. 3 is a block diagram illustrating the configuration of the electronic apparatus of FIG. 2 according to an embodiment of the disclosure;

FIG. 4 is a perspective view illustrating the exterior of the electronic apparatus according to an embodiment of the disclosure;

FIG. 5 is a perspective view illustrating the exterior of the electronic apparatus according to an embodiment of the disclosure;

FIG. 6 is a perspective view illustrating the exterior of the electronic apparatus according to an embodiment of the disclosure;

FIG. 7 is a perspective view illustrating the exterior of the electronic apparatus according to an embodiment of the disclosure;

FIG. 8 is a perspective view illustrating a state in which the electronic apparatus in FIG. 7 is rotated according to an embodiment of the disclosure;

FIG. 9 is a flow chart for illustrating operations of performing a keystone function and a leveling function according to an embodiment of the disclosure;

FIG. 10 is a diagram for illustrating a horizontal inclination according to an embodiment of the disclosure;

FIG. 11 is a diagram for illustrating a vertical inclination according to an embodiment of the disclosure;

FIG. 12 is a diagram for illustrating a horizontal distortion according to an embodiment of the disclosure;

FIG. 13 is a diagram for illustrating a horizontal distortion, a horizontal inclination, and a vertical inclination of an electronic apparatus according to an embodiment of the disclosure;

FIG. 14 is a diagram for illustrating a projection direction of an electronic apparatus according to an embodiment of the disclosure;

FIG. 15 is a flow chart for illustrating a projecting operation in consideration of a horizontal projection direction according to an embodiment of the disclosure;

FIG. 16 is a flow chart for illustrating a projecting operation in consideration of a horizontal projection direction according to an embodiment of the disclosure;

FIG. 17 is a diagram for illustrating an operation of performing a keystone function in consideration of a vertical inclination according to an embodiment of the disclosure;

FIG. 18 is a diagram for illustrating an operation of performing a keystone function in consideration of a horizontal inclination according to an embodiment of the disclosure;

FIG. 19 is a flow chart for illustrating a projecting operation in consideration of a horizontal projection direction according to an embodiment of the disclosure;

FIG. 20 is a diagram for illustrating an operation of performing a leveling function in consideration of a horizontal distortion according to an embodiment of the disclosure;

FIG. 21 is a diagram for illustrating operations of performing a keystone function and a leveling function according to an embodiment of the disclosure;

FIG. 22 is a flow chart for illustrating a projecting operation in consideration of a vertical projection direction according to an embodiment of the disclosure;

FIG. 23 is a flow chart for illustrating a projecting operation in consideration of a vertical projection direction according to an embodiment of the disclosure;

FIG. 24 is a flow chart for illustrating an operation of providing a manual manipulation UI according to an embodiment of the disclosure;

FIG. 25 is a diagram for illustrating a rotating function of a projection image according to an embodiment of the disclosure;

FIG. 26 is a diagram for illustrating a size change function and a location change function of a projection image according to an embodiment of the disclosure;

FIG. 27 is a diagram for illustrating an operation of specifying a projection area according to an embodiment of the disclosure;

FIG. 28 is a flow chart for illustrating an operation that is performed in case a state of an electronic apparatus is changed according to an embodiment of the disclosure;

FIG. 29 is a flow chart for illustrating an operation that is performed in case a predetermined object is identified on a projection surface according to an embodiment of the disclosure;

FIG. 30 is a diagram for illustrating an operation of outputting a projection image in consideration of a predetermined object according to an embodiment of the disclosure;

FIG. 31 is a flow chart for illustrating an operation of outputting a projection image in consideration of whether an electronic apparatus vibrates according to an embodiment of the disclosure;

FIG. 32 is a flow chart for illustrating an operation that is performed in case a predetermined object is identified on a projection surface according to an embodiment of the disclosure;

FIG. 33 is a diagram for illustrating an operation of outputting a projection image in consideration of an edge part of a wall according to an embodiment of the disclosure;

FIG. 34 is a flow chart for illustrating an operation that is performed in case a predetermined object is identified on a projection surface according to an embodiment of the disclosure;

FIG. 35 is a flow chart for illustrating an operation that is performed in case a predetermined object is identified on a projection surface according to an embodiment of the disclosure;

FIG. 36 is a diagram for illustrating an operation of outputting a projection image in consideration of a foot object of a user according to an embodiment of the disclosure;

FIG. 37 is a flow chart for illustrating an operation of outputting a projection image in consideration of location information of an external apparatus according to an embodiment of the disclosure;

FIG. 38 is a diagram for illustrating an operation of outputting a projection image in consideration of location information of a screen according to an embodiment of the disclosure;

FIG. 39 is a diagram for illustrating an operation of outputting a projection image in consideration of location information of a mobile apparatus according to an embodiment of the disclosure; and

FIG. 40 is a flow chart for illustrating a controlling method of an electronic apparatus according to an embodiment of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Further, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

In addition, in this specification, expressions such as “have,” “may have,” “include,” and “may include” denote the existence of such characteristics (e.g.: elements such as numerical values, functions, operations, and components), and are not intended to exclude the existence of additional characteristics.

Further, the expression “at least one of A or B” should be interpreted to mean any one of “A” or “B” or “A and B.”

Also, the expressions “first,” “second,” and the like used in this specification may be used to describe various elements regardless of any order and/or degree of importance. Further, such expressions are used only to distinguish one element from another element, and are not intended to limit the elements.

In addition, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Singular expressions include plural expressions, as long as they do not obviously mean differently in the context. Also terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Further, a plurality of “modules” or “parts” may be integrated into at least one module and implemented as at least one processor, except “modules” or “parts” which need to be implemented as specific hardware.

Also, the term “user” may refer to a person who uses an electronic apparatus or an apparatus using an electronic apparatus (e.g.: an artificial intelligence electronic apparatus).

Hereinafter, one or more embodiments of the disclosure will be described in more detail with reference to the accompanying drawings.

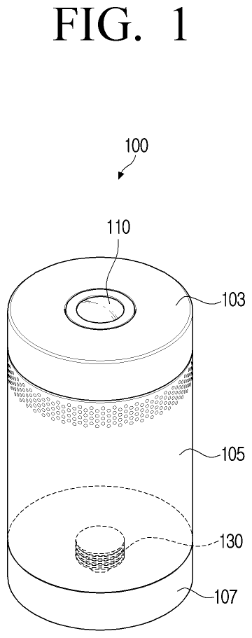

FIG. 1 is a perspective view illustrating an exterior of an electronic apparatus 100 according to an embodiment of the disclosure.

Referring to FIG. 1, the electronic apparatus 100 may include a head 103, a main body 105, a projection lens 110, a connector 130, or a cover 107.

The electronic apparatus 100 may be devices in various forms. The electronic apparatus 100 may be a projector device that enlarges and projects an image to a wall or a screen, and the projector device may be a liquid crystal display (LCD) projector or a digital light processing (DLP) type projector that uses a digital micromirror device (DMD).

In addition, the electronic apparatus 100 may be a home or an industrial display device, or an illumination device used in daily life, or an audio device including an audio module. Also, the electronic apparatus 100 may be implemented as a portable communication device (e.g.: a smartphone), a computer device, a portable multimedia device, a wearable device, a home appliance device, or the like. The electronic apparatus 100 according to an embodiment of the disclosure is not limited to the above-described devices, and may be implemented as an electronic apparatus 100 having two or more functions of the above-described devices. For example, the electronic apparatus 100 may be used as a display device, an illumination device, or an audio device as its projector function is turned off and its illumination function or speaker function is turned on based on a manipulation of the processor, or may be used as an artificial intelligence (AI) speaker including a microphone or a communication device.

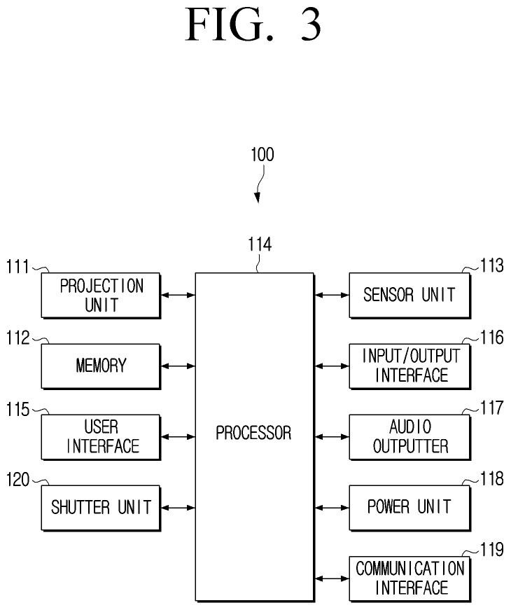

The main body 105 is a housing constituting the exterior, and may support or protect components of the electronic apparatus 100 (e.g., components illustrated in FIG. 3) that are arranged inside the main body 105. The shape of the main body 105 may be close to a cylindrical shape as illustrated in FIG. 1. However, the shape of the main body 105 is not limited thereto, and according to one or more embodiments of the disclosure, the main body 105 may be implemented in various geometrical shapes such as a column having polygonal cross sections, a cone, or a sphere.

The main body 105 may have a size enabling the main body to gripped or moved by a user with his/her one hand, or may be implemented in a micro size enabling the main body to be easily carried by the user. Also, the main body 105 may have a size enabling the main body to be held on a table or coupled to an illumination device.

The material of the main body 105 may be implemented as matt metal or a synthetic resin so that the user's fingerprint or dust may not be smeared on the main body. Alternatively, the exterior of the main body 105 may consist of a slick glossy material.

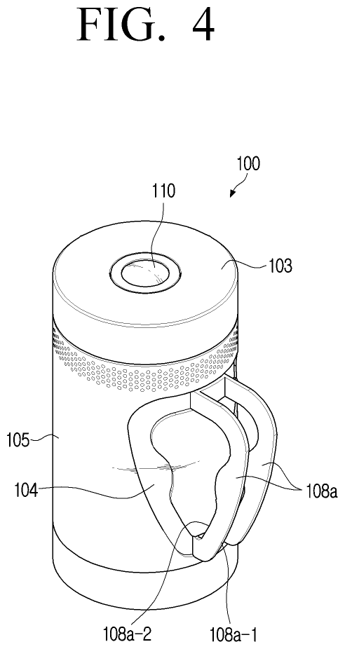

The main body 105 may have a friction area formed in a partial area of the exterior of the main body 105 for the user to grip and move the main body 105. Alternatively, the main body 105 may have a bent gripping part or a support 108a (refer to FIG. 4) positioned in at least a partial area for the user to grip the main body 105.

The projection lens 110 may be formed on one surface of the main body 105, and project light that passed through a lens array to the outside of the main body 105. The projection lens 110 according to one or more embodiments of the disclosure may be an optical lens that was low-dispersion coated for reducing chromatic aberration. The projection lens 110 may be a convex lens or a condensing lens, and the projection lens 110 according to an embodiment of the disclosure may adjust a focus by adjusting positions of a plurality of sub lenses.

The head 103 may be provided to be coupled to one surface of the main body 105 to thus support and protect the projection lens 110. The head 103 may be coupled to the main body 105 to be swiveled within a predetermined angle range based on one surface of the main body 105.

The head 103 may be automatically or manually swiveled by the user or the processor to thus freely adjust a projection angle of the projection lens 110. Alternatively, the head 103 may include a neck that is coupled to the main body 105 and extends from the main body 105, and the head 103 may thus adjust the projection angle of the projection lens 110 by being tilted backward or forward.

The electronic apparatus 100 may project light or an image to a select position by adjusting a projection angle of the projection lens 110 while adjusting a direction of the head 103 in a state in which the position and the angle of the main body 105 are fixed. In addition, the head 103 may include a handle that the user may grip after rotating the head in a select direction.

A plurality of openings may be formed on an outer circumferential surface of the main body 105. Through the plurality of openings, audio output from an audio outputter may be output to the outside of the main body 105 of the electronic apparatus 100. The audio outputter may include a speaker, and the speaker may be used for general uses such as reproduction of multimedia or reproduction of recording, output of a voice, etc.

According to an embodiment of the disclosure, the main body 105 may include a radiation fan provided therein, and in case the radiation fan is operated, air or heat in the main body 105 may be discharged through the plurality of openings. Accordingly, the electronic apparatus 100 may discharge heat generated due to the driving of the electronic apparatus 100 to the outside, and prevent overheating of the electronic apparatus 100.

The connector 130 may connect the electronic apparatus 100 with an external device to transmit or receive electronic signals, or receive power from the outside. The connector 130 according to an embodiment of the disclosure may be physically connected with an external device. Here, the connector 130 may include an input/output interface, and connect its communication with the external device in a wired or wireless manner or receive power from the external device. For example, the connector 130 may include a high-definition multimedia interface (HDMI) connection terminal, a universal serial bus (USB) connection terminal, a secure digital (SD) card accommodating groove, an audio connection terminal, or a power consent. Alternatively, the connector 130 may include Bluetooth, wireless-fidelity (Wi-Fi), or a wireless charge connection module, which is connected with the external device wirelessly.

In addition, the connector 130 may have a socket structure connected to an external illumination device, and may be connected to a socket accommodating groove of the external illumination device to receive the power. The size and the specification of the connector 130 having the socket structure may be implemented in various ways in consideration of an accommodating structure of an external device that may be coupled thereto. For example, a diameter of a joining portion of the connector 130 may be implemented as 26 mm according to an international standard E26, and in this case, the electronic apparatus 100 may be coupled to an external illumination device such as a stand in place of a light bulb that is generally used. When being fastened to a conventional socket positioned on a ceiling, the electronic apparatus 100 may be a structure that is projected from up to down, and in case the electronic apparatus 100 is not rotated by socket coupling, the screen cannot be rotated either. Accordingly, in order for the electronic apparatus 100 to rotate even when power is supplied while the electronic apparatus 100 is socket-coupled, the head 103 may be swiveled on one surface of the main body 105 and adjust the projection angle while the electronic apparatus 100 is socket-coupled to the stand on the ceiling, and thus the screen may be projected to a selected location or the screen may be rotated.

The connector 130 may include a coupling sensor, and the coupling sensor may detect whether the connector 130 is coupled to an external device, its coupling state, or its coupling target, and transmit the same to the processor, and the processor may control the driving of the electronic apparatus 100 based on the received detection value.

The cover 107 may be coupled to or separated from the main body 105, and protect the connector 130 so that the connector 130 is not exposed to the outside at all times. The cover 107 may have a shape continued from the main body 105 as illustrated in FIG. 1 or may be implemented to correspond to the shape of the connector 130. The cover 107 may support the electronic apparatus 100, and the electronic apparatus 100 may be used by being coupled to or held on an external holder while being coupled to the cover 107.

In the electronic apparatus 100 according to one or more embodiments of the disclosure, a battery may be provided inside the cover 107. The battery may include, for example, a primary cell that cannot be recharged, a secondary cell that may be recharged, or a fuel cell.

The electronic apparatus 100 may include a camera module, and the camera module may capture a still image and a video. According to an embodiment of the disclosure, the camera module may include at least one lens, an image sensor, an image signal processor, or a flash.

The electronic apparatus 100 may include a protection case for the electronic apparatus 100 to be easily carried while being protected. Alternatively, the electronic apparatus 100 may include a stand that supports or fixes the main body 105, or a bracket that may be coupled to a wall surface or a partition.

In addition, the electronic apparatus 100 may be connected with various external devices by using its socket structure, and provide various functions. For example, the electronic apparatus 100 may be connected to an external camera device by using the socket structure. The electronic apparatus 100 may provide an image stored in the connected camera device or an image that is currently being captured using a projecting part 111. As another example, the electronic apparatus 100 may be connected to a battery module by using the socket structure to receive power. The electronic apparatus 100 may be connected to an external device by using the socket structure, but this is merely an example, and the electronic apparatus 100 may be connected to an external device by using another interface (e.g., a USB, etc.).

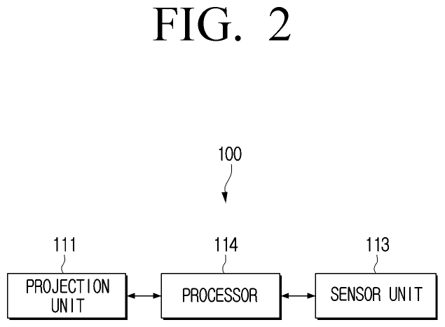

FIG. 2 is a block diagram illustrating a configuration of the electronic apparatus 100 according to an embodiment of the disclosure.

Referring to FIG. 2, the electronic apparatus 100 may include a projection unit 111, a sensor assembly 113, and a processor 114.

The projection unit 111 may output an image that is to be projected from the electronic apparatus 100 onto a projection surface. The projection unit 111 may include a projection lens 110.

The projection unit 111 may perform a function of outputting an image onto a projection surface. Detailed explanation related to the projection unit 111 will be described in FIG. 3. Here, the component projecting an image is described as a projector, but the electronic apparatus 100 may project an image in various ways. The projection unit 111 may include a projection lens 110. Also, the projection surface may be a part of a physical space in which an image is output, or a separate screen.

The sensor assembly 113 may include at least one sensor that acquires sensing data. The sensor assembly 113 may include a sensor that senses data related to the state information (or the arrangement state information) of the electronic apparatus 100. For example, the sensor assembly 113 may include at least one of an acceleration sensor or a time of flight (ToF) sensor. Also, the sensor assembly 113 may include a sensor that senses information related to a projection surface. For example, the sensor assembly 113 may include at least one of a depth camera, a distance sensor, or an infrared sensor.

The processor 114 may perform an overall control operation of the electronic apparatus 100. The processor 114 performs a function of controlling the overall operations of the electronic apparatus 100.

The electronic apparatus 100 may include a processor 114 that acquires state information including at least one of horizontal inclination information, vertical inclination information, or horizontal distortion information based on sensing data acquired through the sensor assembly 113, and if at least one of the horizontal inclination information or the vertical inclination information in the state information is acquired, performs a keystone function, and if the horizontal distortion information in the state information is acquired, performs a leveling function, and outputs a projection image onto a projection surface.

The keystone function may be performed according to various methods.

According to an embodiment, the processor 114 may automatically perform the keystone function. The processor 114 may automatically perform the keystone function based on the acquired state information. For example, if at least one of the horizontal inclination information or the vertical inclination information in the state information is acquired, the processor 114 may perform the keystone function based on at least one of the acquired horizontal inclination information or vertical inclination information. In case the keystone function is automatically performed, the keystone function may be described as an auto-keystone function.

According to an embodiment, the keystone function may be performed manually. The processor 114 may perform the keystone function according to the user's input or the user's manipulation. For example, the user may use the keystone function so that a projection image becomes a rectangle by manipulating the electronic apparatus 100 while viewing the image projected onto a projection surface.

The leveling function may be performed according to various methods.

According to an embodiment, the processor 114 may automatically perform the leveling function. The processor 114 may automatically perform the leveling function based on the acquired state information. For example, if the horizontal distortion information in the state information is acquired, the processor 114 may perform the leveling function based on the acquired horizontal distortion information. In case the leveling function is automatically performed, the leveling function may be described as an auto-leveling function.

According to an embodiment, the leveling function may be performed manually. The processor 114 may perform the leveling function according to the user's input or the user's manipulation. For example, the user may use the leveling function so that a projection image is rotated by manipulating the electronic apparatus 100 while viewing the image projected onto a projection surface.

The processor 114 may acquire sensing data through the sensor assembly 113. The sensor assembly 113 may include at least one sensor that acquires state information of the electronic apparatus 100. For example, the sensor assembly 113 may include at least one of an acceleration sensor or a time of flight (ToF) sensor. Also, the sensor assembly 113 may include at least one of a depth camera, a distance sensor, or an infrared sensor.

The state information may mean information indicating whether the electronic apparatus 100 is inclined. The state information may include at least one of horizontal inclination information, vertical inclination information, or horizontal distortion information. The horizontal inclination information may indicate the degree of rotation of the electronic apparatus 100 in a left or a right direction.

The horizontal inclination information may be acquired based on a projection surface. The processor 114 may identify a projection surface, and measure how much the electronic apparatus 100 is distorted in the horizontal direction with respect to the projection surface. Then, the processor 114 may acquire the degree to how much the electronic apparatus 100 is distorted in the horizontal direction with respect to the projection surface as the horizontal inclination information. The processor 114 may use at least one of the depth camera, the distance sensor, or the infrared sensor included in the sensor assembly 113 to acquire information related to the projection surface.

The vertical inclination information may indicate the degree of rotation of the electronic apparatus 100 in a left or a right direction. As an example, the processor 114 may directly acquire the vertical inclination information through the acceleration sensor included in the sensor assembly 113. As another example, the vertical inclination information may be acquired based on a projection surface. The processor 114 may identify a projection surface, and measure how much the electronic apparatus 100 is distorted in the vertical direction with respect to the projection surface. Then, the processor 114 may acquire the degree how much the electronic apparatus 100 is distorted in the vertical direction with respect to the projection surface as the vertical inclination information. The processor 114 may use at least one of the depth camera, the distance sensor, or the infrared sensor included in the sensor assembly 113 to acquire information related to the projection surface.

The horizontal distortion information may indicate the degree that the electronic apparatus 100 is distorted in a clockwise direction or a counter-clockwise direction in a direction toward a projection surface.

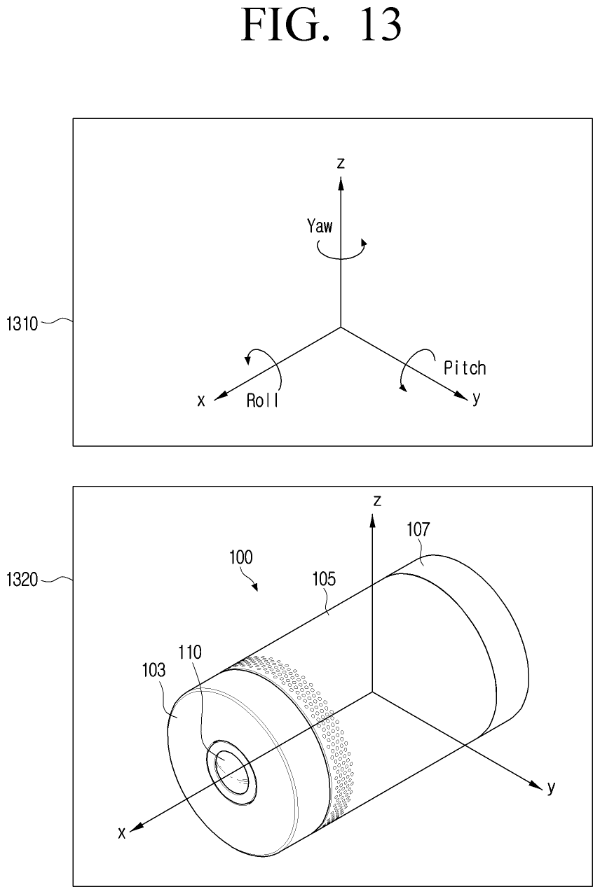

The horizontal inclination information, the vertical inclination information, and the horizontal distortion information may respectively be described as the first axis rotation information, the second rotation axis information, and the third axis rotation information. Also, detailed explanation related to the state information will be described in FIG. 13.

Also, if at least one of the horizontal inclination information or the vertical inclination information in the state information is acquired, the processor 114 may perform the keystone function.

The keystone function may be a function for resolving a problem that an image in a trapezoid form is output onto a projection surface due to an inclination of the electronic apparatus 100. Also, the keystone function may be a function of correcting an image so that an image in a trapezoid form output onto a projection surface is output as an image in a rectangle or a square form. The keystone function may be described as a keystone correction.

The keystone function performed based on the horizontal inclination information may be described as a horizontal keystone function, and the keystone function performed based on the vertical inclination information may be described as a vertical keystone function.

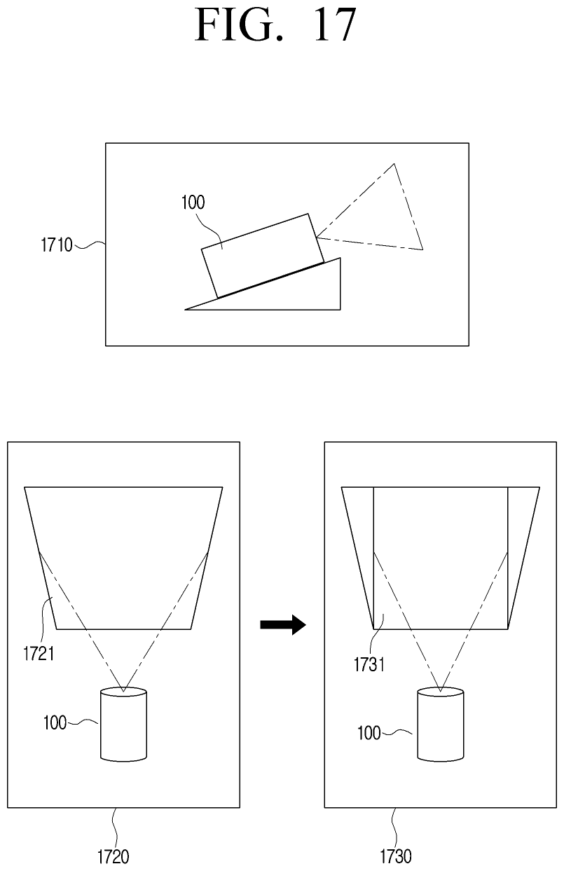

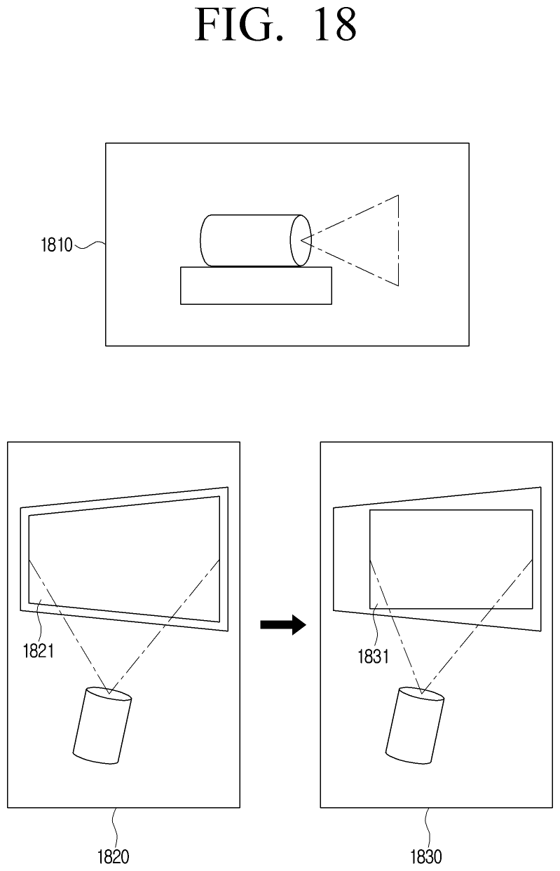

The keystone function performed based on the horizontal inclination information will be described in FIG. 18. Also, the keystone function performed based on the vertical inclination information will be described in FIG. 17.

Also, the processor 114 may perform the leveling function based on the horizontal distortion information in the state information.

The leveling function may mean a function of rotating an image. The processor 114 may perform control so that a projection image is output by rotating an image as much as a specific angle by using the leveling function.

According to an embodiment, the processor 114 may perform the leveling function by using software. The processor 114 may correct an image so that a rotated image is output by using the leveling function. Then, the processor 114 may control the projection unit 111 so that the rotated image is output.

According to an embodiment, the processor 114 may perform the leveling function by using hardware. The processor 114 may rotate an image by rotating the projection lens 110 included in the projection unit 111. Also, the processor 114 may rotate an image by controlling a fixing member included in the electronic apparatus 100. The fixing member may mean a member that contacts a specific surface so that the electronic apparatus 100 can be fixed. The processor 114 may perform control so that an image is output while being rotated, by rotating the fixing member or adjusting its length.

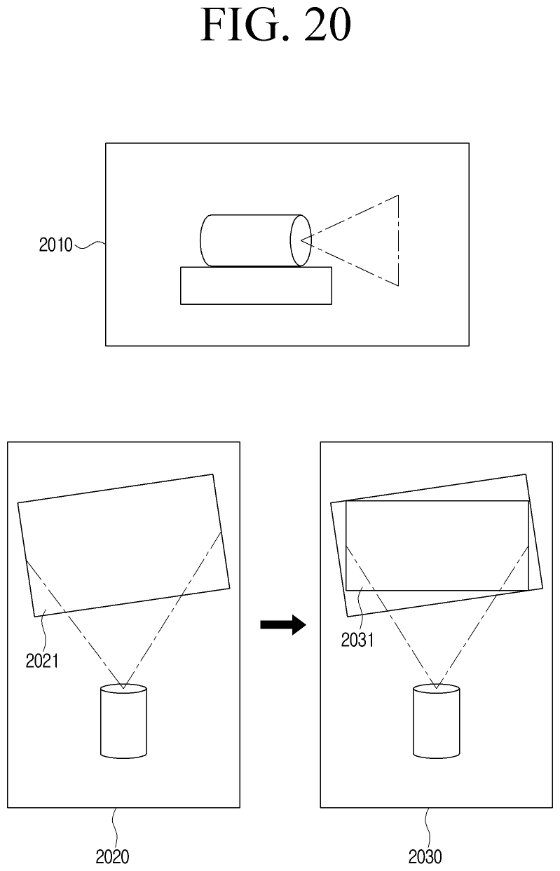

The leveling function performed based on the horizontal distortion information will be described in FIG. 20.

Also, the processor 114 may acquire a final projection image by performing at least one function from among the keystone function and the leveling function, and control the projection unit 111 to output the final projection image onto a projection surface.

As the projection image is output after at least one function from among the keystone function and the leveling function is performed, the electronic apparatus 100 may provide a projection image appropriate for the user.

The processor 114 may provide a projection image according to various methods.

According to an embodiment, the processor 114 may output a corrected projection image after at least one function from among the keystone function and the leveling function is performed.

According to an embodiment, the processor 114 may output an original projection image before the keystone function and the leveling function are performed, and output a corrected projection image after at least one function from among the keystone function and the leveling function is performed.

Also, the processor 114 may identify a projection direction based on state information. The projection direction may indicate information indicating where a projection image is to be output. For example, the projection direction may include one direction among a horizontal forward direction, a horizontal up-down direction, a horizontal diagonal direction, a vertical ceiling direction, and a vertical bottom direction. The processor 114 may determine whether to perform the keystone function and the leveling function based on the projection direction.

The horizontal forward direction may be the projection direction of the electronic apparatus 100 in a state in which a projection surface of a horizontal wall surface and the electronic apparatus 100 face each other in a straight line. If the projection direction is the horizontal forward direction, the processor 114 may perform only the leveling function.

The horizontal up-down direction may be the projection direction of the electronic apparatus 100 in a state wherein the electronic apparatus 100 is inclined in an up-down direction, while a projection surface of a horizontal wall surface and the electronic apparatus 100 face each other. If the projection direction is the horizontal up-down direction, the processor 114 may perform only the keystone function.

The horizontal diagonal direction may be the projection direction of the electronic apparatus 100 in a state in which the electronic apparatus 100 is inclined in up-down/left-right directions, while a projection surface of a horizontal wall surface and the electronic apparatus 100 face each other. If the projection direction is the horizontal diagonal direction, the processor 114 may perform both the keystone function and the leveling function.

The vertical ceiling direction may be the projection direction of the electronic apparatus 100 in a state in which a projection surface of the ceiling and the electronic apparatus 100 face each other. If the projection direction is the vertical ceiling direction, the processor 114 may perform only the keystone function.

The vertical bottom direction may be the projection direction of the electronic apparatus 100 in a state in which a projection surface of the bottom and the electronic apparatus 100 face each other. If the projection direction is the vertical bottom direction, the processor 114 may perform only the keystone function.

The processor 114 may identify a projection direction, and selectively apply the keystone function or the leveling function according to the projection direction. In the case of using the two kinds of functions in all situations, the time spent for image conversion will increase, and thus the processing time can be reduced by omitting the keystone function or the leveling function in a specific situation as in the aforementioned explanation.

The processor 114 may acquire information related to a projection surface, identify the sizes of a projection area in which a projection image is output and the projection image based on the information related to the projection surface, and output the projection image in the projection area based on the size of the projection image. Also, the information related to the projection surface may include at least one of pattern information of the projection surface, color information of the projection surface, or distance information between the projection surface and the electronic apparatus 100.

The processor 114 may determine the size of the projection image and an output focus based on the distance information between the projection surface and the electronic apparatus 100.

The processor 114 may acquire the information related to the projection surface based on the sensing data acquired by using the sensor assembly 113. The sensor assembly 113 may include at least one of a depth camera, a distance sensor, or an infrared sensor. Also, the processor 114 may acquire the information related to the projection surface based on the sensing data acquired through the sensor assembly 113, and identify the projection surface in the information related to the projection surface.

The projection surface may mean the surface wherein the projection image is output. Also, the projection area may mean a specific area in which the projection image is output in the entire area of the projection surface.

The information related to the projection surface may include space information around the electronic apparatus 100. The information related to the projection surface may include information on the size of the projection area, the location of the projection area, or the state information between the projection area and the electronic apparatus 100. The state information may be acquired based on the relation between the projection area and the electronic apparatus 100. For example, the horizontal inclination information may indicate how much the electronic apparatus 100 rotates in a left-right direction based on the projection area. Also, the vertical inclination information may indicate how much the electronic apparatus 100 rotates in an up-down direction based on the projection area. In addition, the horizontal distortion information may indicate how much the electronic apparatus 100 rotates in a clockwise direction or a counter-clockwise direction based on the projection area.

The processor 114 may identify the size of the projection image based on the size of the projection area. Then, the processor 114 may correct the original image based on the size of the projection image. Then, the processor 114 may control the projection unit 111 to output the projection image that was corrected to fit the size of the projection image in the projection area.

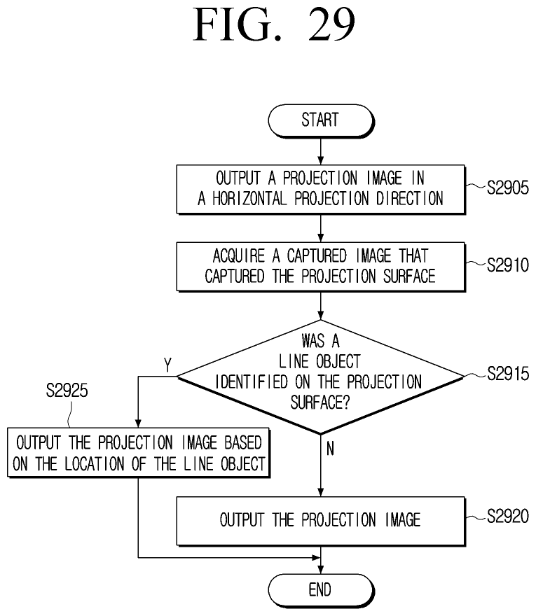

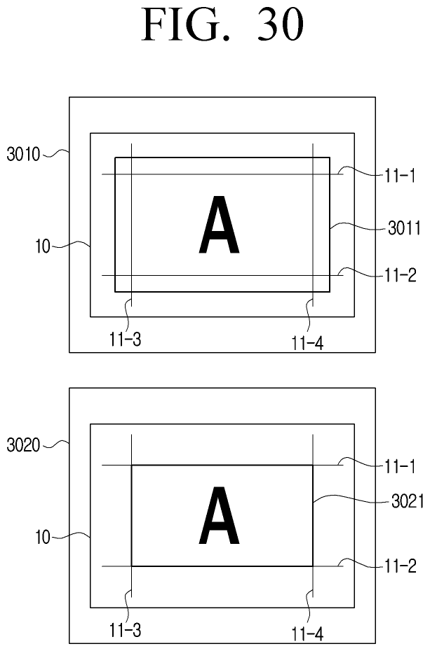

Pattern information of the projection surface may include information indicating which pattern the projection surface includes. For example, in case the projection surface includes a striped pattern, the processor 114 may identify the location of a line object included in the projection surface. Then, the processor 114 may correct the projection image based on the identified location of the line object. Detailed explanation in this regard will be described in FIG. 29 and FIG. 30.

Color information of the projection surface may include information indicating which colors the projection surface includes. In case the color of the projection surface is a single color, the processor 114 may correct the color of the projection image in consideration of the color of the projection surface.

If a predetermined object is identified, the processor 114 may output a projection image in consideration of the location of the predetermined object.

The predetermined object may include at least one of a line object, an edge object, an object, or a person object. The predetermined object may be set by the user.

The processor 114 may acquire a captured image that captured the front side of the electronic apparatus 100. The processor 114 may identify an object based on the acquired captured image.

The processor 114 may identify whether the predetermined object is included in the captured image. As an example, the processor 114 may identify an object consisting of a line included in the captured image as a line object. As another example, the processor 114 may identify an object corresponding to an edge of the projection surface included in the captured image as an edge object. As still another example, the processor 114 may identify an object that covers the projection surface included in the captured image as a product object. As still another example, the processor 114 may identify an object that covers the projection surface and has a shape of a person included in the captured image as a person object.

The predetermined object is a line object, and when a line object is identified, the processor 114 may output a projection image so that the line object and the outer rim portion of the projection image are in parallel.

The operation of outputting the projection image so that the line object and the outer rim portion of the projection image are in parallel may mean an operation of outputting the outer rim portion (or the outer rim line) of the projection image in the location in which the line object was output.

The processor 114 may output the projection image so that the distance between the line object and the outer rim portion of the projection image becomes smaller than or equal to a threshold value. As the threshold value is smaller, the projection image may be output to be closer to the line object.

The processor 114 may identify a line object, and identify the location of the line object. The processor 114 may change the projection area in consideration of the location of the line object. The processor 114 may change the projection area so that the line object and one outer rim portion (or one outer rim line) among the four outer rim portions (or outer rim lines) included by the projection area are in parallel. Then, the processor 114 may control the projection unit 111 to output the projection image based on the changed projection area.

One or more embodiments of outputting a projection image in consideration of a line object will be described in FIG. 29 and FIG. 30.

The predetermined object is an edge object, and the processor 114 may output a projection image onto one projection surface among a plurality of projection surfaces divided by the edge object.

The processor 114 may identify the edge object, and identify the location of the edge object. The processor 114 may change the projection area in consideration of the location of the edge object. The processor 114 may change the location of the projection area so that the edge object is not included in the projection area. Then, the processor 114 may control the projection unit 111 to output the projection image based on the changed projection area.

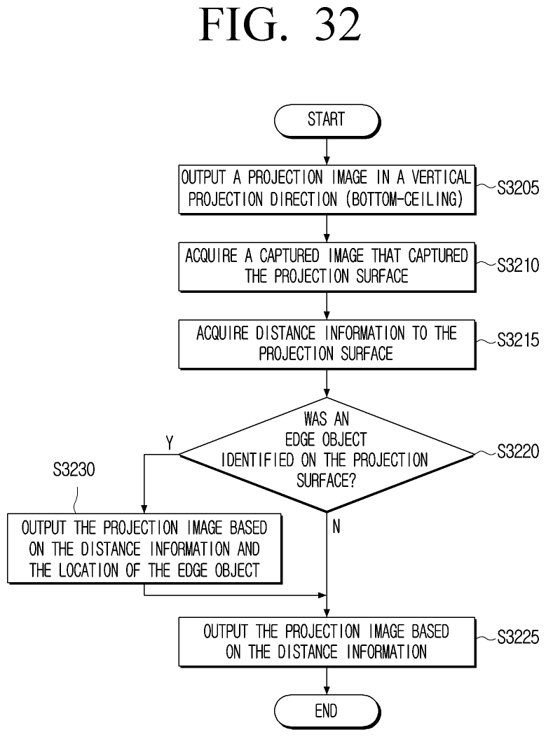

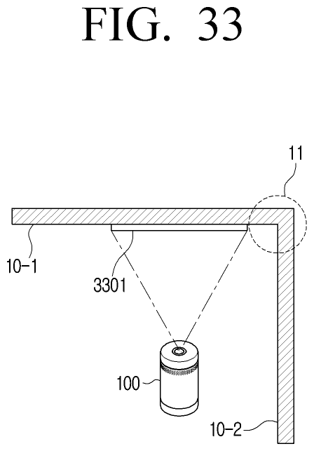

One or more embodiments of outputting a projection image in consideration of an edge object will be described in FIG. 32 and FIG. 33.

The electronic apparatus 100 may further include a camera, and the processor 114 may acquire vibration information based on sensing data acquired through the sensor assembly 113, and if the vibration information is changed by greater than or equal to a threshold value, acquire a captured image through the camera, and identify the predetermined object based on the captured image.

Here, the camera was described as different hardware from the sensor assembly 113, but depending on implementation examples, a sensor performing the function of a camera such as an image sensor may be included in the sensor assembly 113.

The processor 114 may acquire vibration information through a vibration sensor included in the sensor assembly 113. Then, if the vibration information is changed by greater than or equal to the threshold value, the processor 114 may determine that the electronic apparatus 100 is arranged in a space wherein vibration is strong. For example, a case wherein vibration is strong may mean a situation wherein a projection image is output inside a moving object such as a ship, an airplane, etc. In case vibration is strong, it may be difficult to identify the predetermined object only with sensing data acquired through the sensor assembly 113. This is because the locations of the identified objects may continuously change due to the vibration.

Accordingly, if the vibration information or the vibration data is changed by greater than or equal to the threshold value, the processor 114 may acquire a captured image by capturing the front side (or the surroundings) of the electronic apparatus 100 through the camera. Then, the processor 114 may identify the predetermined object based on the captured image. The captured image is fixed data, and in the case of analyzing an object by using the captured image, the accuracy may be much higher than in the case of simply using sensing data. Accordingly, if the vibration information is greater than or equal to the threshold value, the processor 114 may identify the predetermined object based on a captured image acquired through the camera but not the sensing data.

If a predetermined event is identified, the processor 114 may provide a user interface (UI) for providing at least one function among a rotation function of a projection image, a size change function of a projection image, and a location change function of a projection image.

The predetermined event may be an event in which the user's instruction for manual setting is input or an event wherein a projection image is initially output.

The predetermined event may be an event in which it is set such that a UI is displayed for the user to directly correct an image manually.

According to an embodiment, if a user input for the user to select a specific button or a setting item directly is acquired, the processor 114 may provide a UI for correcting an image manually in response to the user input.

According to an embodiment, in case a projection image is initially output after the state is changed to a state wherein the power of the electronic apparatus 100 was supplied (or a normal operation state), the processor 114 may provide a UI for correcting an image manually.

After at least one of the keystone function or the leveling function was performed based on the state information, if movement information greater than or equal to a threshold value is acquired based on the sensing data of the sensor assembly 113, the processor 114 may perform at least one of the keystone function or the leveling function.

The processor 114 may acquire movement information of the electronic apparatus 100 based on the sensing data acquired through the sensor assembly 113, and if the movement information is changed by greater than or equal to the threshold value, the processor 114 may perform at least one of the keystone function or the leveling function again.

The processor 114 may perform a primary correcting operation for the projection image based on the state information. The primary correcting operation may mean an operation of performing at least one function from among the keystone function and the leveling function according to the state information. After performing the primary correcting operation based on the state information, the processor 114 may perform a secondary correcting operation for the projection image based on the movement information. The secondary correcting operation may mean an operation of performing at least one function from among the keystone function and the leveling function according to the movement information.

The processor 114 may acquire movement information of the processor 114 based on whether the sensing data is changed. As an example, the processor 114 may acquire sensing data in real time, and acquire movement information in real time. As another example, the processor 114 may acquire sensing data per predetermined time, and acquire movement information per predetermined time.

If the movement information or the movement data is changed by greater than or equal to the threshold value, the processor 114 may determine that the location of the electronic apparatus 100 changed. In case the location of the electronic apparatus 100 changed, the processor 114 may need to perform the keystone function and the leveling function that it performed previously again. Accordingly, if it is determined that the electronic apparatus 100 moved, the processor 114 may perform at least one of the keystone function or the leveling function again.

If there is a difference between the horizontal inclination information measured on the first time point and the horizontal inclination information measured on the second time point, the processor 114 may newly perform the keystone function based on the horizontal inclination information measured on the second time point. If there is not a difference between the horizontal inclination information measured on the first time point and the horizontal inclination information measured on the second time point, the processor 114 may not perform a separate keystone function.

Also, if there is a difference between the vertical inclination information measured on the first time point and the vertical inclination information measured on the second time point, the processor 114 may newly perform the keystone function based on the vertical inclination information measured on the second time point. If there is not a difference between the vertical inclination information measured on the first time point and the vertical inclination information measured on the second time point, the processor 114 may not perform a separate keystone function.

In addition, if there is a difference between the horizontal distortion information measured on the first time point and the horizontal distortion information measured on the second time point, the processor 114 may newly perform the leveling function based on the horizontal distortion information measured on the second time point. If there is not a difference between the horizontal distortion information measured on the first time point and the horizontal distortion information measured on the second time point, the processor 114 may not perform a separate leveling function.

The electronic apparatus 100 may further include a communication interface 119 communicating with external apparatuses 200, 300, and the processor 114 may acquire location information of the external apparatuses 200, 300, and identify a projection area wherein a projection image is output based on the location information of the external apparatuses 200, 300.

The external apparatuses 200, 300 may mean apparatuses used for identifying a projection area. The external apparatuses 200, 300 may include communication interfaces on their own, and may communicate with the communication interface 119 of the electronic apparatus 100. The external apparatuses 200, 300 may transmit signals indicating their locations to the electronic apparatus 100, and the processor 114 may acquire the location information of the external apparatuses 200, 300 based on the signals transmitted by the external apparatuses 200, 300. Then, the processor 114 may identify a projection area based on the location information of the external apparatuses 200, 300. Then, the processor 114 may output a projection image in the identified projection area.

If the location information of the external apparatuses 200, 300 is changed, the processor 114 may change the projection area wherein a projection image is output based on the changed location information.

In case the locations of the external apparatuses 200, 300 are changed, the location of the projection area may be changed. Accordingly, if the locations of the external apparatuses 200, 300 are changed, the processor 114 may perform at least one function from among the keystone function or the leveling function based on the changed location of the projection area. If only the horizontal inclination was changed and the vertical inclination was maintained, the processor 114 may perform only the horizontal keystone function.

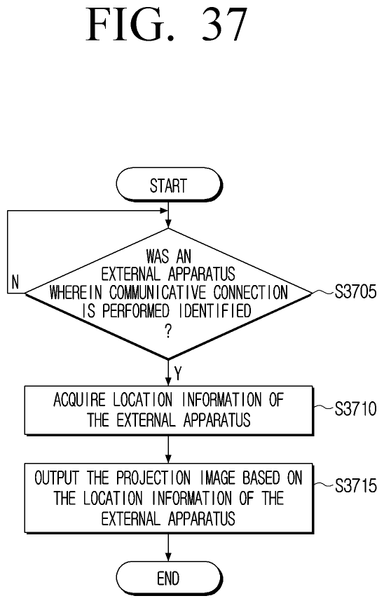

Detailed explanation related to the external apparatuses 200, 300 will be described in FIG. 37 to FIG. 39.

FIG. 3 is a block diagram illustrating the configuration of the electronic apparatus 100 of FIG. 2 in detail.

Referring to FIG. 3, the electronic apparatus 100 may include the projection unit 111, the memory 112, the sensor assembly 113, the processor 114, a user interface 115, an input/output interface 116, an audio outputter 117, a power unit 118, a communication interface 119, and a shutter unit 120. The configuration illustrated in FIG. 3 is merely an example, and some components may be omitted, or new components may be added.

Contents overlapping with those already described in FIG. 2 will be omitted.

The projection unit 111 is a component that projects an image to the outside. The projection unit 111 according to an embodiment of the disclosure may be implemented in various projection types (e.g., a cathode-ray tube (CRT) type, a liquid crystal display (LCD) type, a digital light processing (DLP) type, a laser type, etc.). As an example, the CRT type has basically the same principle as the principle of a CRT monitor. The CRT type may display an image on the screen by enlarging the image by using a lens in front of a cathode-ray tube (CRT). The CRT type may be divided into a one-tube type and a three-tube type based on the number of cathode-ray tubes, and in the three-tube type, cathode-ray tubes of red, green, and blue may be separated from one another.

As another example, the LCD type is a type of displaying an image by allowing light emitted from a light source to pass through a liquid crystal. The LCD type is divided into a single-panel type and a three-panel type. In the three-plate type, light emitted from a light source may be separated into red, green and blue in a dichroic mirror (which is a mirror that reflects only light of a specific color and allows the rest to pass therethrough), may then pass through a liquid crystal, and may then be collected into one place again.

As still another example, the DLP type is a type of displaying an image by using a digital micromirror device (DMD) chip. The projector of the DLP type may include a light source, a color wheel, a DMD chip, a projection lens, etc. Light emitted from the light source may be colored as it passes through a rotating color wheel. The light that passed through the color wheel may be input into the DMD chip. The DMD chip may include numerous micromirrors and reflect the light input into the DMD chip. The projection lens may perform a role of expanding the light reflected from the DMD chip to an image size.

As still another example, the laser type may include a diode pumped solid state (DPSS) laser and a galvanometer. The laser type that outputs various colors may use a laser in which three DPSS lasers are respectively installed for red, green, and blue (RGB) colors, and their optical axes overlap each other by using a special mirror. The galvanometer may include a mirror and a high-power motor, and move the mirror at a high speed. For example, the galvanometer may rotate the mirror at up to 40 KHz/sec. The galvanometer may be mounted according to a scanning direction, and in general, a projector performs planar scanning, and the galvanometer may thus also be disposed by being divided into x and y axes.

The projection unit 111 may include light sources of various types. For example, the projection unit 111 may include at least one light source among a lamp, a light emitting diode (LED), and a laser.

The projection unit 111 may output an image in a screen ratio of 4:3, a screen ratio of 5:4, and a wide screen ratio of 16:9, based on a purpose of the electronic apparatus 100 or the user's setting, etc., and may output images in various resolutions such as wide video graphics array WVGA (854*480 pixels), super video graphics array SVGA (800*600 pixels), extended graphics array XGA (1024*768 pixels), wide extended graphics array WXGA (1280*720 pixels), WXGA (1280*800 pixels), super extended graphics array SXGA (1280*1024 pixels), ultra extended graphics array UXGA (1600*1200 pixels), full high-definition HD (1920*1080 pixels), etc., according to the screen ratio.

The projection unit 111 may perform various functions for adjusting an output image under the control of the processor 114. For example, the projection unit 111 may perform functions such as zoom, keystone, quick corner (or four corner) keystone, lens shift, etc.

The projection unit 111 may enlarge or reduce an image according to its distance (i.e., projection distance) to the screen. That is, the projection unit 111 may perform the zoom function according to its distance to the screen. The zoom function may include a hardware method of adjusting a screen size by moving a lens, and a software method of adjusting a screen size by cropping an image, or the like. If the zoom function is performed, it may be necessary to adjust a focus of an image. For example, a method of adjusting a focus may include a manual focusing method, an electric focusing method, etc. The manual focusing method means a method of manually adjusting a focus, and the electric focusing method means a method in which the projector automatically adjusts a focus by using a motor built therein when the zoom function is performed. When performing the zoom function, the projection unit 111 may provide a digital zoom function through software, and may provide an optical zoom function in which the zoom function is performed by moving the lens through a driving unit.

In addition, the projection unit 111 may perform the keystone function. When a height does not match a front projection, the screen may be distorted up or down. The keystone function means a function of correcting a distorted screen. For example, in case a distortion occurs in a left-right direction of the screen, the distortion may be corrected using a horizontal keystone, and in case a distortion occurs in an up-down direction of the screen, the distortion may be corrected using a vertical keystone. The quick corner (or four corner) keystone function is a function of correcting the screen in case a balance between corner areas of the screen is not appropriate while the central area of the screen is normal. The lens shift function is a function of moving the screen as it is in case the screen is outside the screen area.

The projection unit 111 may provide the zoom/keystone/focusing functions by automatically analyzing a surrounding environment and a projection environment without a user input. The projection unit 111 may automatically provide the zoom/keystone/focusing functions, based on the distance between the electronic apparatus 100 and the screen, information about a space where the electronic apparatus 100 is currently positioned, information about an amount of ambient light, or the like, which were detected by the sensor (e.g., a depth camera, a distance sensor, an infrared sensor, an illumination sensor, etc.).

In addition, the projection unit 111 may provide an illumination function by using a light source. In particular, the projection unit 111 may provide the illumination function by outputting a light source by using the LED. According to an embodiment, the projector may include one LED, and according to an embodiment, the electronic apparatus may include a plurality of LEDs. The projection unit 111 may output a light source by using a surface-emitting LED depending on implementation examples. Here, the surface-emitting LED may mean an LED in which an optical sheet is disposed on the upper side of the LED for the light source to be evenly dispersed and output. If a light source is output through the LED, the light source may be evenly dispersed through the optical sheet, and the light source dispersed through the optical sheet may be introduced into a display panel.

The projection unit 111 may provide the user with a dimming function for adjusting the intensity of a light source. If a user input for adjusting the intensity of a light source is received from the user through the user interface 240 (e.g., a touch display button or a dial), the projection unit 111 may control the LED to output the intensity of the light source corresponding to the received user input.

In addition, the projection unit 111 may provide the dimming function, based on a content analyzed by the processor 114 without a user input. The projection unit 111 may control the LED to output the intensity of a light source, based on information (e.g., the content type, the content brightness, etc.) on the currently-provided content.

The projection unit 111 may control a color temperature by the control of the processor 114. The processor 114 may control a color temperature based on a content. If it is identified that a content is to be output, the processor 114 may obtain color information for each frame of the content whose output is determined. The processor 114 may then control the color temperature based on the obtained color information for each frame. The processor 114 may obtain at least one main color of the frame based on the color information for each frame. The processor 114 may then adjust the color temperature based on the obtained at least one main color. For example, the color temperature that the processor 114 may adjust may be divided into a warm type or a cold type. Here, it is assumed that the frame to be output (hereinafter, an output frame) includes a fire scene. The processor 114 may identify (or obtain) that the main color is red based on the color information included in the current output frame. The processor 114 may then identify the color temperature corresponding to the identified main color (red). The color temperature corresponding to the red color may be the warm type. The processor 114 may use an artificial intelligence model to obtain the color information or the main color of a frame. According to an embodiment, the artificial intelligence model may be stored in the electronic apparatus 100 (e.g., the memory 112). According to an embodiment, the artificial intelligence model may be stored in an external server which may communicate with the electronic apparatus 100.

The electronic apparatus 100 may be interlocked with an external device to control the illumination function. The electronic apparatus 100 may receive illumination information from the external device. The illumination information may include at least one of brightness information or color temperature information, which was set by the external device. The external device may mean a device connected to the same network as the electronic apparatus 100 (e.g., an Internet of Things (IoT) device included in the same home/work network) or a device not connected to the same network as the electronic apparatus 100 but capable of communicating with the electronic apparatus (e.g., a remote control server). For example, it is assumed that an external illumination device (e.g., an IoT device) included in the same network as the electronic apparatus 100 outputs a red light at the brightness of 50. The external lighting device (e.g., an IoT device) may directly or indirectly transmit the illumination information (e.g., information indicating that the red light is being output at the brightness of 50) to the electronic apparatus 100. The electronic apparatus 100 may control the output of the light source based on the illumination information received from the external illumination device. For example, if the illumination information received from the external illumination device includes the information indicating that the red light is output at the brightness of 50, the electronic apparatus 100 may output the red light at the brightness of 50.

The electronic apparatus 100 may control the illumination function based on biometric information. The processor 114 may obtain the user's biometric information. The biometric information may include at least one of the body temperature, the heart rate, the blood pressure, the breath, or the electrocardiogram of the user. The biometric information may include various information other than the aforementioned information. For example, the electronic apparatus may include a sensor for measuring the biometric information. The processor 114 may obtain the biometric information of the user through the sensor, and control the output of a light source based on the obtained biometric information. As another example, the processor 114 may receive the biometric information from an external device through the input/output interface 116. The external device may mean a portable communication device (e.g., a smartphone or a wearable device) of the user. The processor 114 may obtain the biometric information of the user from the external device, and control the output of the light source based on the obtained biometric information. Depending on implementation examples, the electronic apparatus may identify whether the user is sleeping, and if it is identified that the user is sleeping (or preparing to sleep), the processor 114 may control the output of the light source based on the user's biometric information.

The memory 112 may store at least one instruction on the electronic apparatus 100. In addition, the memory 112 may store an operating system (O/S) for driving the electronic apparatus 100. The memory 112 may also store various software programs or applications for operating the electronic apparatus 100 according to the various embodiments of the disclosure. Further, the memory 112 may include a semiconductor memory such as a flash memory, or a magnetic storage medium such as a hard disk.

The memory 112 may store various software modules for operating the electronic apparatus 100 according to the various embodiments of the disclosure, and the processor 114 may control the operations of the electronic apparatus 100 by executing the various software modules stored in the memory 112. That is, the memory 112 may be accessed by the processor 114, and reading/recording/correction/deletion/update and the like of data by the processor 114 may be performed.

In the disclosure, the term “memory 112” may be used as a meaning including the memory 112, a read only memory (ROM) or a random access memory (RAM) in the processor 114, or a memory card (for example, a micro secure digital (SD) card or a memory stick) mounted on the electronic apparatus 100.

The sensor assembly 113 may include at least one sensor. The sensor assembly 113 may include at least one of an inclination sensor for detecting the inclination of the electronic apparatus 100 or an image sensor for capturing an image. Here the inclination sensor may be an acceleration sensor or a gyro sensor, and the image sensor may mean a camera or a depth camera. In addition, the sensor assembly 113 may include various sensors other than the inclination sensor or the image sensor. For example, the sensor assembly 113 may include an illumination sensor and a distance sensor. The sensor assembly 113 may also include a LiDAR sensor.

The user interface 115 may include various types of input devices. For example, the user interface 115 may include a physical button. The physical button may include a function key, a direction key (e.g., a four-direction key), or a dial button. According to an embodiment, the physical button may be implemented as a plurality of keys. According to an embodiment, the physical button may be implemented as one key. In case the physical button is implemented as one key, the electronic apparatus 100 may receive a user input in which the one key is pressed for a threshold time or longer. If a user input in which one key is pressed for the threshold time or longer is received, the processor 114 may perform a function corresponding to the user input. For example, the processor 114 may provide the illumination function based on the user input.

In addition, the user interface 115 may receive a user input by using a non-contact method. In the case of receiving a user input through a contact method, a physical force should be transmitted to the electronic apparatus. There may thus be a need for a method of controlling the electronic apparatus regardless of a physical force. The user interface 115 may receive a user gesture, and may perform an operation corresponding to the received user gesture. The user interface 115 may receive the user gesture through the sensor (e.g., an image sensor or an infrared sensor).

In addition, the user interface 115 may receive a user input by using a touch method. For example, the user interface 115 may receive a user input through a touch sensor. According to an embodiment, the touch method may be implemented as the non-contact method. For example, the touch sensor may determine whether a user body approached within a threshold distance. The touch sensor may identify a user input even in case the user does not contact the touch sensor. Depending on implementation examples, the touch sensor may identify a user input in which the user contacts the touch sensor.

The electronic apparatus 100 may receive a user input in various ways other than the user interface described above. According to an embodiment, the electronic apparatus 100 may receive a user input through an external remote control device. The external remote control device may be a remote control device corresponding to the electronic apparatus 100 (e.g., a control device dedicated to the electronic apparatus) or a portable communication device (e.g., a smartphone or a wearable device) of the user. The portable communication device of the user may store an application for controlling the electronic apparatus. The portable communication device may obtain a user input through the application stored therein, and transmit the obtained user input to the electronic apparatus 100. The electronic apparatus 100 may receive the user input from the portable communication device, and perform an operation corresponding to the user's control command.

The electronic apparatus 100 may receive a user input by using voice recognition. According to an embodiment, the electronic apparatus 100 may receive a user voice through the microphone included in the electronic apparatus. According to an embodiment, the electronic apparatus 100 may receive a user voice from the microphone or an external device. The external device may obtain a user voice through the microphone of the external device, and transmit the obtained user voice to the electronic apparatus 100. The user voice transmitted from the external device may be audio data or digital data converted from the audio data (e.g., audio data converted to a frequency domain, etc.). The electronic apparatus 100 may perform an operation corresponding to the received user voice. The electronic apparatus 100 may receive the audio data corresponding to the user voice through the microphone. The electronic apparatus 100 may then convert the received audio data to the digital data. The electronic apparatus 100 may then convert the converted digital data to text data by using a speech-to-text (STT) function. According to an embodiment, the speech-to-text (STT) function may be directly performed by the electronic apparatus 100, and according to an embodiment, the speech-to-text (STT) function may be performed by an external server.

The electronic apparatus 100 may transmit the digital data to the external server. The external server may convert the digital data to text data, and obtain control command data based on the converted text data. The external server may transmit the control command data (which may here also include the text data) to the electronic apparatus 100. The electronic apparatus 100 may perform an operation corresponding to the user voice based on the obtained control command data.

The electronic apparatus 100 may provide a voice recognition function by using one assistance (or an artificial intelligence agent such as Bixby™, etc.), but this is merely an example, and the electronic apparatus 100 may provide the voice recognition function through a plurality of assistances. The electronic apparatus 100 may provide the voice recognition function by selecting one of the plurality of assistances based on a trigger word corresponding to the assistance or a specific key included in a remote controller.

The electronic apparatus 100 may receive a user input by using a screen interaction. A screen interaction may mean a function in which the electronic apparatus identifies whether a predetermined event is generated through an image projected onto the screen (or the projection surface), and obtains a user input based on the predetermined event. The predetermined event may mean an event in which a predetermined object is identified in a specific location (e.g., a location to which a UI for receiving a user input is projected). The predetermined object may include at least one of a user body part (e.g., a finger), a pointer, or a laser point. In case the predetermined object is identified in the location corresponding to the projected UI, the electronic apparatus 100 may identify that a user input for selecting the projected UI was received. For example, the electronic apparatus 100 may project a guide image so that a UI is displayed on the screen. The electronic apparatus 100 may then identify whether the user selects the projected UI. If the predetermined event is identified in the location of the projected UI, the electronic apparatus 100 may identify that the user selected the projected UI. The projected UI may include at least one item. The electronic apparatus 100 may perform spatial analysis to identify whether the predetermined event exists in the location of the projected UI. The electronic apparatus 100 may perform the spatial analysis through the sensor (e.g., an image sensor, an infrared sensor, a depth camera, a distance sensor, etc.). The electronic apparatus 100 may identify whether the predetermined event is generated in the specific location (the location to which the UI is projected) by performing the spatial analysis. Then, in case it is identified that the predetermined event is generated in the specific location (the location to which the UI is projected), the electronic apparatus 100 may identify that a user input for selecting the UI corresponding to the specific location was received.

The input/output interface 116 is a component for inputting or outputting at least one of an audio signal or an image signal. The input/output interface 116 may receive at least one of an audio signal or an image signal from an external device, and output a control command to the external device.

The input/output interface 116 according to an embodiment of the disclosure may be implemented as a wired input/output interface of at least one of a high definition multimedia interface (HDMI), a mobile high-definition link (MHL), a universal serial bus (USB), a USB C-type, a display port (DP), a thunderbolt, a video graphics array (VGA) port, a red-green-blue (RGB) port, a D-subminiature (D-SUB), or a digital visual interface (DVI). According to an embodiment, the wired input/output interface may be implemented as an interface inputting or outputting only an audio signal and an interface inputting or outputting only an image signal, or implemented as one interface inputting or outputting both an audio signal and an image signal.

In addition, the electronic apparatus 100 may receive data through the wired input/output interface, but this is merely an example, and the electronic apparatus 100 may receive power through the wired input/output interface. For example, the electronic apparatus 100 may receive power from an external battery through a USB C-type, or receive power from an outlet through a power adapter. As another example, the electronic apparatus 100 may receive power from an external device (e.g., a laptop computer or a monitor, etc.) through a display port (DP).

The input/output interface 116 according to an embodiment of the disclosure may be implemented as a wireless input/output interface that performs communication by using at least one of communication methods such as wireless-fidelity (Wi-Fi), Wi-Fi direct, Bluetooth, ZigBee, 3rd generation (3G), 3rd generation partnership project (3GPP), or long term evolution (LTE). Depending on implementation examples, the wireless input/output interface may be implemented as an interface inputting or outputting only an audio signal and an interface inputting or outputting only an image signal, or implemented as one interface inputting or outputting both an audio signal and an image signal.

In addition, the electronic apparatus 100 may be implemented such that an audio signal is input through a wired input/output interface, and an image signal is input through a wireless input/output interface. Alternatively, the electronic apparatus 100 may be implemented such that an audio signal is input through a wireless input/output interface, and an image signal is input through a wired input/output interface.

The audio outputter 117 is a component that outputs an audio signal. In particular, the audio outputter 117 may include an audio output mixer, an audio signal processor, and an audio output module. The audio output mixer may mix a plurality of audio signals to be output as at least one audio signal. For example, the audio output mixer may mix an analog audio signal and another analog audio signal (e.g., an analog audio signal received from the outside) as at least one analog audio signal. The audio output module may include a speaker or an output terminal. According to an embodiment, the audio output module may include a plurality of speakers. In this case, the audio output module may be disposed in the main body, and audio emitted while covering at least a portion of a diaphragm of the audio output module may pass through a waveguide to be transmitted to the outside of the main body. The audio output module may include a plurality of audio output units, and the plurality of audio output units may be symmetrically arranged on the exterior of the main body, and accordingly, audio may be emitted to all directions, i.e., all directions in 360 degrees.

The power unit 118 may receive power from the outside and supply power to the various components of the electronic apparatus 100. The power unit 118 according to an embodiment of the disclosure may receive power in various ways. As an example, the power unit 118 may receive power by using the connector 130 as illustrated in FIG. 1. In addition, the power unit 118 may receive power by using a direct current (DC) power cord of 220V. However, the disclosure is not limited thereto, and the electronic apparatus 100 may receive power by using a USB power cord, or may receive power by using a wireless charging method.

In addition, the power unit 118 may receive power by using an internal battery or an external battery. The power unit 118 according to an embodiment of the disclosure may receive power through the internal battery. For example, the power unit 118 may charge power of the internal battery by using at least one of the DC power cord of 220V, the USB power cord, or a USB C-Type power cord, and may receive power through the charged internal battery. In addition, the power unit 118 according to an embodiment of the disclosure may receive power through the external battery. For example, the power unit 118 may receive power through the external battery if connection of the electronic apparatus and the external battery is performed through various wired communication methods such as the USB power code, the USB C-type power code, or a socket groove. That is, the power unit 118 may directly receive power from the external battery, or charge the internal battery through the external battery and receive power from the charged internal battery.

The power unit 118 according to an embodiment of the disclosure may receive power by using at least one of the aforementioned plurality of power supply methods.

With respect to power consumption, the electronic apparatus 100 may have power consumption of a predetermined value (e.g., 43 W) or less due to the socket type and other standards, etc. The electronic apparatus 100 may vary power consumption to reduce the power consumption when using the battery. That is, the electronic apparatus 100 may vary power consumption based on the power supply method and the power usage amount, etc.

The electronic apparatus 100 according to an embodiment of the disclosure may provide various smart functions.

The electronic apparatus 100 may be connected to a portable terminal device controlling the electronic apparatus 100, and the screen output from the electronic apparatus 100 may be controlled by a user input which is input from the portable terminal device. For example, the portable terminal device may be implemented as a smartphone including a touch display, and the electronic apparatus 100 may receive screen data provided by the portable terminal device from the portable terminal device and output the data, and the screen output from the electronic apparatus 100 may be controlled according to a user input which is input from the portable terminal device.

The electronic apparatus 100 may perform connection with the portable terminal device through various communication methods such as Miracast, Airplay, wireless Dalvik Executable (DEX), a remote personal computer (PC) method, etc., and may share a content or music provided from the portable terminal device.

In addition, the portable terminal device and the electronic apparatus 100 may be connected to each other by various connection methods. According to an embodiment, the portable terminal device may search for the electronic apparatus 100 and perform wireless connection therebetween, or the electronic apparatus 100 may search for the portable terminal device and perform wireless connection therebetween. The electronic apparatus 100 may then output the content provided from the portable terminal device.

According to an embodiment, after the portable device is positioned around the electronic apparatus 100 while a specific content or music is being output from the portable terminal device, if a predetermined gesture (e.g., a motion tap view) is detected through the display of the portable terminal device, the electronic apparatus 100 may output the content or the music that is being output from the portable terminal device.

According to an embodiment, if the portable terminal device becomes close to the electronic apparatus 100 by a predetermined distance or less (e.g., a non-contact tap view), or the portable terminal device contacts the electronic apparatus 100 twice at a short interval (e.g. a contact tap view) while a specific content or music is being output from the portable terminal device, the electronic apparatus 100 may output the content or the music that is being output from the portable terminal device.

In the aforementioned example, it was described that the same screen as the screen provided by the portable terminal device is provided at the electronic apparatus 100, but the disclosure is not limited thereto. That is, if connection between the portable terminal device and the electronic apparatus 100 is constructed, a first screen provided by the portable terminal device may be output on the portable terminal device, and a second screen provided by the portable device that is different from the first screen may be output on the electronic apparatus 100. For example, the first screen may be a screen provided by a first application installed in the portable terminal device, and the second screen may be a screen provided by a second application installed in the portable terminal device. For example, the first screen and the second screen may be screens different from each other that are provided by one application installed in the portable terminal device. In addition, for example, the first screen may be a screen including a UI in a remote controller form for controlling the second screen.

The electronic apparatus 100 according to the disclosure may output a standby screen. For example, the electronic apparatus 100 may output a standby screen in case connection between the electronic apparatus 100 and an external device was not performed, or there is no input received during a predetermined time from the external device. A condition for the electronic apparatus 100 to output the standby screen is not limited to the above-described examples, and the standby screen may be output based on various conditions.

The electronic apparatus 100 may output the standby screen in the form of a blue screen, but the disclosure is not limited thereto. For example, the electronic apparatus 100 may obtain an atypical object by extracting only the shape of a specific object from the data received from the external device, and output the standby screen including the obtained atypical object.

The shutter unit 120 may include at least one of a shutter, a fixing member, a rail, a body, or a motor.

The shutter may block light output from the projection unit 111. The fixing member may fix the position of the shutter. The rail may be a path to move the shutter and the fixing member. The body may be a component including the shutter and the fixing member. The motor may be a component that generates driving power for operations such as movement of a component (e.g., movement of the body) or rotation of a component (e.g., rotation of the shutter) in the shutter unit 120.

FIG. 4 is a perspective view illustrating the exterior of the electronic apparatus 100 according to other embodiments of the disclosure.

Referring to FIG. 4, the electronic apparatus 100 may include a support (or a “handle”) 108a.

The support 108a in various embodiments may be a handle or a ring that is provided for the user to grip or move the electronic apparatus 100. Alternatively, the support 108a may be a stand that supports the main body 105 while the main body 105 is laid sideways.

As illustrated in FIG. 4, the support 108a may be connected in a hinge structure so as to be coupled to or separated from the outer circumferential surface of the main body 105, and may be selectively separated from or fixed to the outer circumferential surface of the main body 105 depending on the user's needs. The number, shape, or disposition structure of the support 108a may be implemented in various ways without restriction. The support 108a may be built in the main body 105, and taken out and used by the user depending on needs. Alternatively, the support 108a may be implemented as a separate accessory, and attached to or detached from the electronic apparatus 100.

The support 108a may include a first support surface 108a-1 and a second support surface 108a-2. The first support surface 108a-1 may be a surface that faces the outward direction of the main body 105 while the support 108a is separated from the outer circumferential surface of the main body 105, and the second support surface 108a-2 may be a surface that faces the inward direction of the main body 105 while the support 108a is separated from the outer circumferential surface of the main body 105.

The first support surface 108a-1 may be developed from the lower portion to the upper portion of the main body 105 to be farther away from the main body 105, and the first support surface 108a-1 may have a flat or uniformly curved shape. The first support surface 108a-1 may support the main body 105 in case the electronic apparatus 100 is held in such a manner that the outer side surface of the main body 105 is in contact with the bottom, i.e., in case the electronic apparatus 100 is disposed in such a manner that the projection lens 110 is toward the front surface direction. In an example in which the electronic apparatus 100 includes two or more supports 108a, the projection angle of the head 103 and the projection lens 110 may be adjusted by adjusting the interval or the hinge opening angle of the two supports 108a.

The second support surface 108a-2 may be a surface that contacts the user or an external holding structure when the support 108a is supported by the user or the external holding structure, and may have a shape corresponding to a gripping structure of the user's hand or the external holding structure so that the electronic apparatus 100 does not slip in case the electronic apparatus 100 is supported or moved. The user may move the electronic apparatus 100 by making the projection lens 110 face toward the front surface direction, fixing the head 103, and holding the support 108a, and use the electronic apparatus 100 like a flashlight.

The support groove 104 may be a groove structure which is provided in the main body 105 and can accommodate the support 108a when the support 108a is not used, and as illustrated in FIG. 4, the support groove 104 may be implemented as a groove structure corresponding to the shape of the support 108a on the outer circumferential surface of the main body 105. By using the support groove 104, the support 108a may be stored on the outer circumferential surface of the main body 105 when the support 108a is not used, and the outer circumferential surface of the main body 105 may be maintained to be slick.

Alternatively, the support 108a may be a structure that is stored inside the main body 105, and is taken out to the outside of the main body 105 when it is needed. In this case, the support groove 104 may be a structure led into the inside of the main body 105 to accommodate the support 108a, and the second support surface 108a-2 may have a door that adheres to the outer circumferential surface of the main body 105 or opens or closes the separate support groove 104.

The electronic apparatus 100 may include various kinds of accessories that are helpful in using or storing the electronic apparatus 100. For example, the electronic apparatus 100 may include a protection case for the electronic apparatus 100 to be easily carried while being protected. Alternatively, the electronic apparatus 100 may include a tripod that supports or fixes the main body 105, or a bracket that may be coupled to the outer surface of the electronic apparatus 100 and fix the electronic apparatus 100.

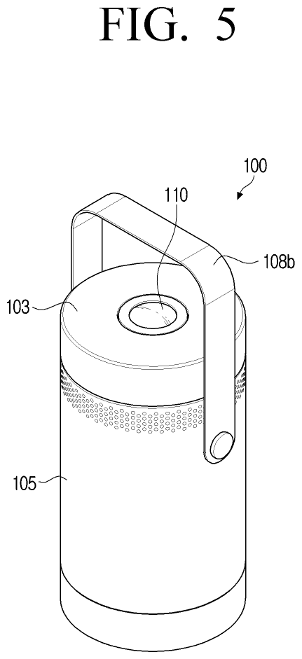

FIG. 5 is a perspective view illustrating the exterior of the electronic apparatus 100 according to one or more embodiments of the disclosure.

Referring to FIG. 5, the electronic apparatus 100 may include a support (or a “handle”) 108b.

The support 108b according to one or more embodiments may be a handle or a ring that is provided for the user to grip or move the electronic apparatus 100. Alternatively, the support 108b may be a stand that supports the main body 105 to be oriented at any angle while the main body 105 is laid sideways.

As illustrated in FIG. 5, the support 108b may be connected with the main body 105 at a predetermined point (e.g., a ⅔-¾ point of the height of the main body) of the main body 105. In case the support 108b is rotated toward the main body, the support 108b may support the main body 105 for the main body 105 to be oriented at any angle while the main body 105 is laid sideways.

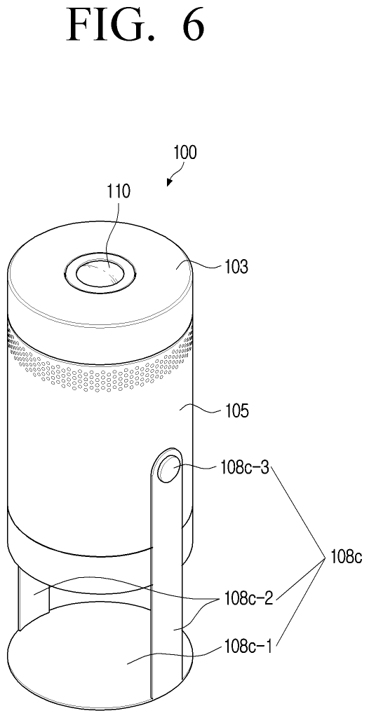

FIG. 6 is a perspective view illustrating the exterior of the electronic apparatus 100 according to one or more embodiments of the disclosure.

Referring to FIG. 6, the electronic apparatus 100 may include a support (or a “handle”) 108c. The support 108c according to one or more embodiments may include a base plate 108c-1 provided to support the electronic apparatus 100 on the ground and two support members 108c-2 connecting the base plate 108c-1 with the main body 105.

According to an embodiment of the disclosure, the two support members 108c-2 may have the same height, and one cross section of each of the two support members 108c-2 may be coupled to or separated from each other by a groove and a hinge member 108c-3 provided on one outer circumferential surface of the main body 105.

The two support members may be hinge-coupled to the main body 105 at a predetermined point (e.g., a ⅓ to 2/4 point of the height of the main body) of the main body 105.

If the two support members and the main body are coupled with each other by the hinge member 108c-3, the main body 105 may be rotated based on a virtual horizontal axis formed by the two hinge members 108c-3, thus adjusting the projection angle of the projection lens 110.

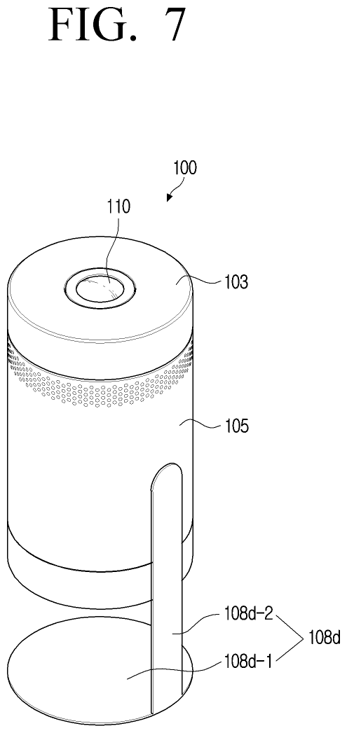

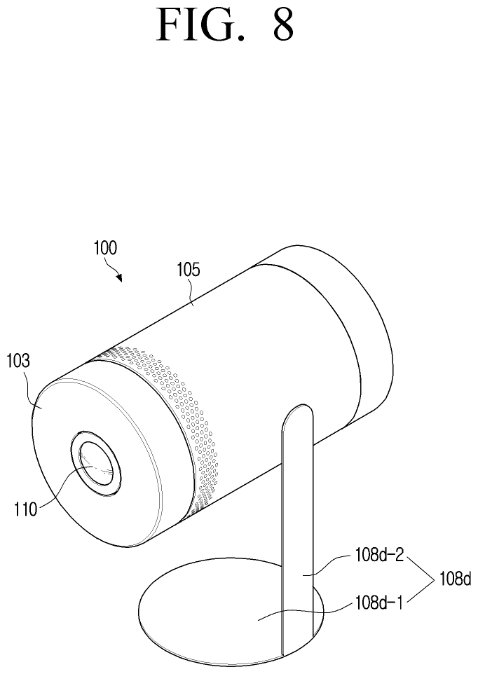

FIG. 6 illustrates an example in which the two support members 108c-2 are connected with the main body 105, but the disclosure is not limited thereto, and as in FIGS. 7 and 8, one support member and the main body 105 may be connected with each other by one hinge member.

FIG. 7 is a perspective view illustrating the exterior of the electronic apparatus 100 according to one or more embodiments of the disclosure.

FIG. 8 is a perspective view illustrating a state wherein the electronic apparatus 100 of FIG. 7 is rotated.

Referring to FIGS. 7 and 8, a support 108d according to one or more embodiments may include a base plate 108d-1 that is provided to support the electronic apparatus 100 on the ground and one support member 108d-2 connecting a base plate 108-c with the main body 105.

In addition, a cross section of the one support member 108d-2 may be coupled to or separated from the main body 105 by a groove and a hinge member provided on one outer circumferential surface of the main body 105.

If the one support member 108d-2 and the main body 105 are coupled with each other by one hinge member, the main body 105 may be rotated based on a virtual horizontal axis formed by the one hinge member, as in FIG. 8.

The support illustrated in FIGS. 4, 5, 6, 7, and 8 is merely an example, and the electronic apparatus 100 can obviously include the support in various positions or shapes.

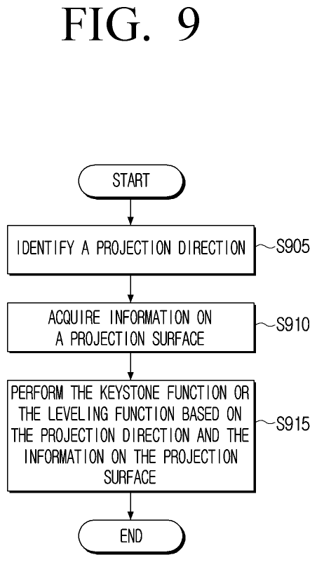

FIG. 9 is a flow chart for illustrating operations of performing a keystone function and a leveling function.

Referring to FIG. 9, the electronic apparatus 100 may identify a projection direction in operation S905. The electronic apparatus 100 may identify a projection direction by using the acceleration sensor.

The electronic apparatus 100 may acquire information on a projection surface in operation S910. The electronic apparatus may acquire information on a projection surface by using the ToF sensor or the camera.

The electronic apparatus 100 may perform at least one function from among the keystone function or the leveling function based on the projection direction and the information on the projection surface.

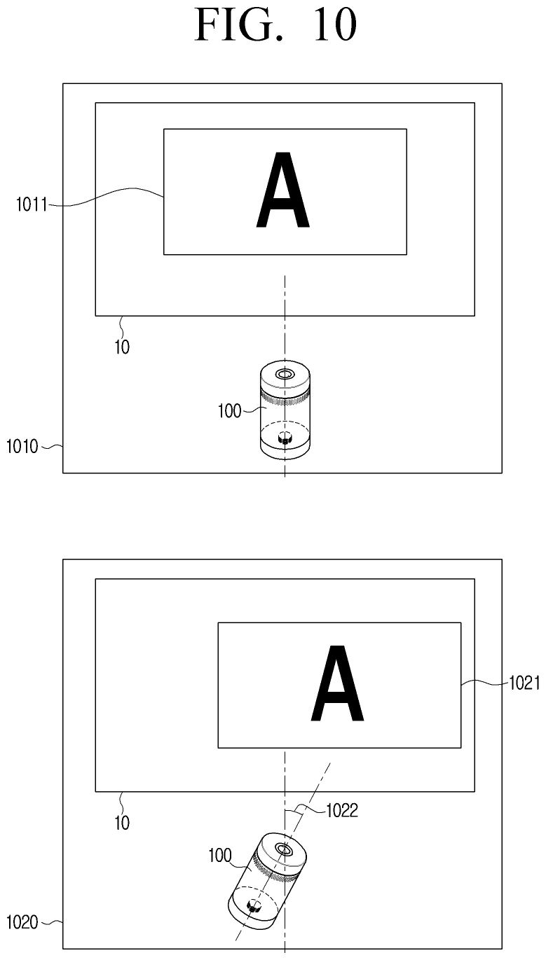

FIG. 10 is a diagram for illustrating a horizontal inclination.

Referring to FIG. 10, according to the embodiment 1010, the electronic apparatus 100 may output a projection image 1011 onto a projection surface 10 in a horizontal projection direction. It is assumed that the horizontal inclination is 0. The horizontal inclination may mean the degree that the electronic apparatus 100 is inclined on the left side or the right side toward the front surface.

According to the embodiment 1020, the electronic apparatus 100 may project a projection image 1021 onto the projection surface 10 in a horizontal projection direction. Here, it is assumed that the horizontal inclination is 30 degrees. In case the horizontal inclination is 30 degrees to the right side, the electronic apparatus 100 may output the projection image 1021 on the right side as much as 30 degrees to the right side from the projection surface 10.

A horizontal inclination may mean a yaw rotation angle based on the z axis.

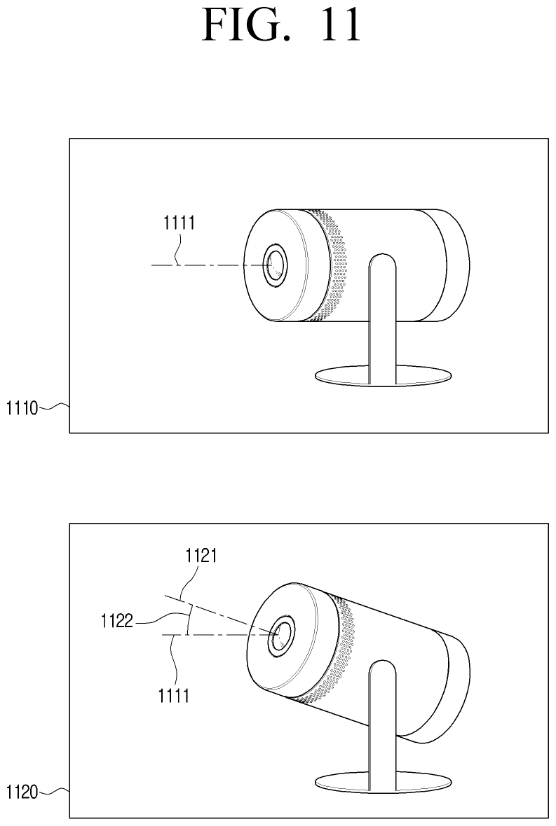

FIG. 11 is a diagram for illustrating a vertical inclination.

Referring to FIG. 11, according to the embodiment 1110, the electronic apparatus 100 may output a projection image on a projection surface in a horizontal projection direction. Here, it is assumed that the vertical inclination is 0 based on a virtual horizontal line 1111. The vertical inclination may mean the degree that the electronic apparatus 100 is inclined to the upper side or the lower side toward the front surface. Here, if the vertical inclination is 0, it may be a situation wherein the projection image is output horizontally.

According to the embodiment 1120, the electronic apparatus 100 may output a projection image on a projection surface in a horizontal projection direction. Here, it is assumed that the vertical inclination is 30 degrees. The vertical inclination 1122 may mean an angle between the virtual horizontal line 1111 of the electronic apparatus 100 and a virtual line 1121 faced by the electronic apparatus 100. In case the vertical inclination is 30 degrees to the upper side, the electronic apparatus 100 may output the projection image as much as 30 degrees to the upper side on the projection surface.

The vertical inclination may mean a pitch rotation angle based on the y axis.

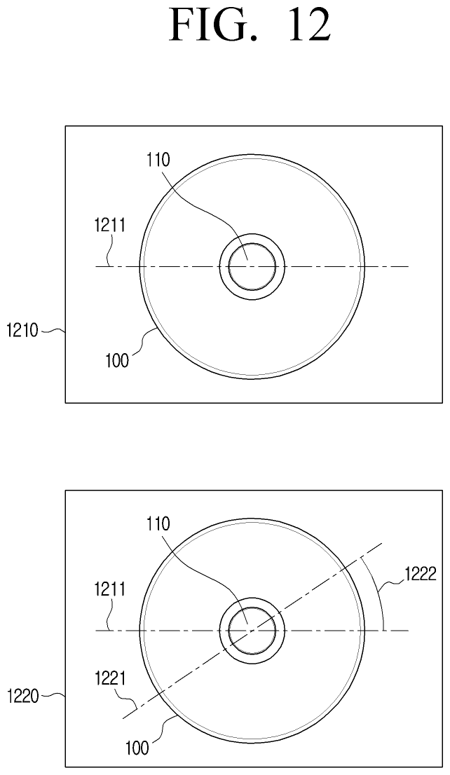

FIG. 12 is a diagram for illustrating a horizontal distortion.

Referring to FIG. 12, according to the embodiment 1210, the electronic apparatus 100 may output a projection image without a horizontal distortion. Here, the reference in which there is no horizontal distortion is indicated as the horizontal line 1211. According to the embodiment 1210, the reference horizontal line and the horizontal line of the electronic apparatus 100 may coincide.

According to the embodiment 1220, there may be horizontal distortion 1222 as much as 30 degrees to the right side in the electronic apparatus 100. Here, the reference horizontal line 1211 and the horizontal line 1221 of the electronic apparatus 100 may be different as much as the horizontal distortion 1222.

The horizontal distortion may mean a roll rotation angle based on the x axis.

FIG. 13 is a diagram for illustrating a horizontal distortion, a horizontal inclination, and a vertical inclination of the electronic apparatus 100.

Referring to the embodiment 1310 in FIG. 13, it is a graph defining rotation directions according to the x, y, and z axes. Rotating based on the x axis may be defined as a roll, rotating based on the y axis may be defined as a pitch, and rotating based on the z axis may be defined as a yaw.

The embodiment 1320 may describe the rotation direction of the electronic apparatus 100 as the rotation direction defined in the embodiment 1310. The horizontal inclination described in FIG. 10 may fall under a yaw of rotating based on the z axis. The vertical inclination described in FIG. 11 may fall under a pitch of rotating based on the y axis. The horizontal distortion described in FIG. 12 may fall under a roll of rotating based on the x axis.

Accordingly, the electronic apparatus 100 may perform a horizontal keystone correction based on a horizontal inclination (a yaw of rotating based on the z axis). Also, the electronic apparatus 100 may perform a vertical keystone correction based on a vertical inclination (a pitch of rotating based on the y axis). Also, the electronic apparatus 100 may perform a leveling correction based on a horizontal distortion (a roll of rotating based on the x axis).

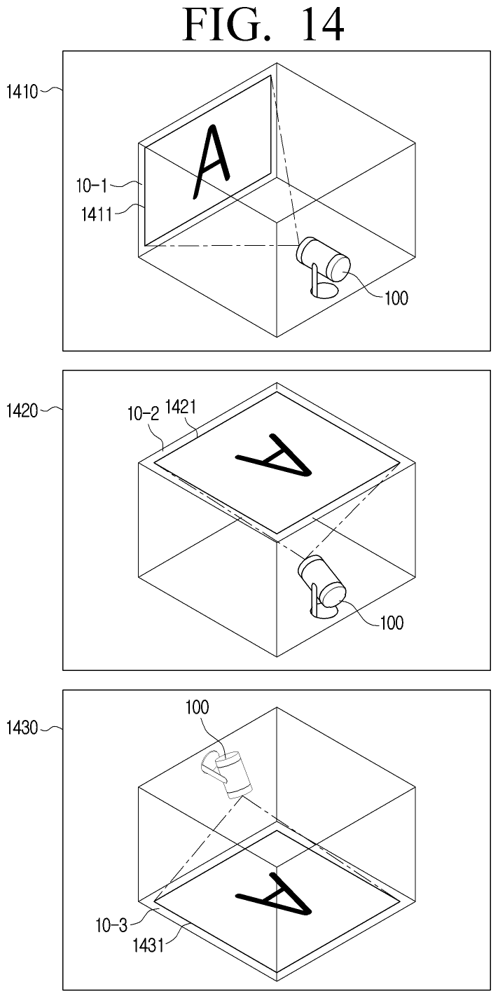

FIG. 14 is a diagram for illustrating a projection direction of the electronic apparatus 100.

Referring to the embodiment 1410 in FIG. 14, the electronic apparatus 100 may output a projection image 1411 onto a first projection surface 10-1 in a horizontal direction. The first projection surface 10-1 may mean the wall surface of the projection space.

Referring to the embodiment 1420 in FIG. 14, the electronic apparatus 100 may output a projection image 1421 onto a second projection surface 10-2 in a vertical direction (from the bottom to the ceiling). The second projection surface 10-2 may mean the ceiling surface of the projection space.

Referring to the embodiment 1430 in FIG. 14, the electronic apparatus 100 may output a projection image 1431 onto a third projection surface 10-3 in a vertical direction (from the ceiling to the bottom). The third projection surface 10-3 may mean the bottom surface of the projection space.

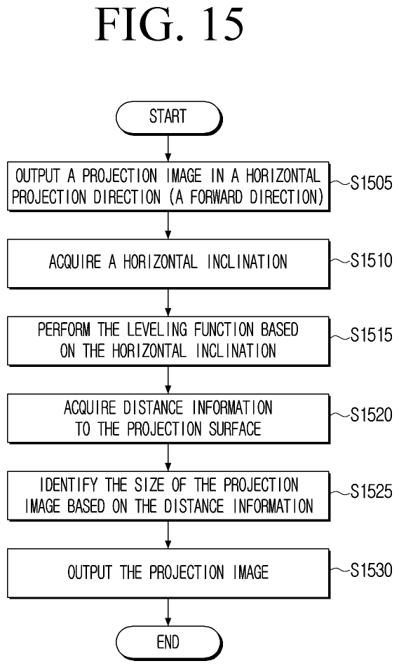

FIG. 15 is a flow chart for illustrating a projecting operation in consideration of a horizontal projection direction according to an embodiment.

Referring to FIG. 15, the electronic apparatus 100 may output a projection image in a horizontal projection direction (the forward direction) in operation S1505. The electronic apparatus 100 may acquire a horizontal inclination in operation S1510. Then, the electronic apparatus 100 may perform the leveling function based on the horizontal inclination.

The electronic apparatus 100 may acquire distance information to the projection surface in operation S1520. Then, the electronic apparatus 100 may identify the size of the projection image based on the distance information in operation S1525. Then, the electronic apparatus 100 may ultimately output the projection image based on the identified size of the projection image in operation S1530.

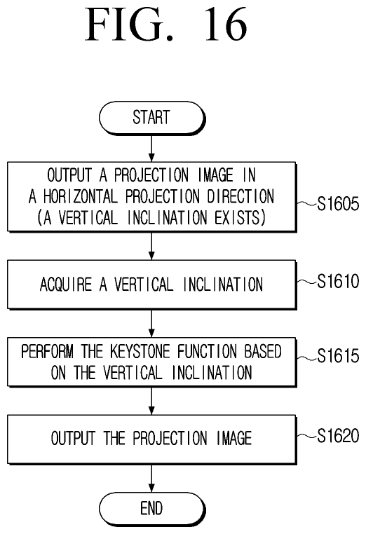

FIG. 16 is a flow chart for illustrating a projecting operation in consideration of a horizontal projection direction according to an embodiment.

Referring to FIG. 16, the electronic apparatus 100 may output a projection image in a horizontal projection direction while a vertical inclination exists in operation S1605. Then, the electronic apparatus 100 may acquire a vertical inclination in operation S1610. Then, the electronic apparatus 100 may perform the keystone function based on the vertical inclination in operation S1615. Then, the electronic apparatus 100 may output a corrected projection image after performing the keystone function in operation S1620.

FIG. 17 is a diagram for illustrating an operation of performing a keystone function in consideration of a vertical inclination.

Referring to the embodiment 1710 in FIG. 17, the electronic apparatus 100 may output a projection image while a vertical inclination exits.

Referring to the embodiment 1720, the electronic apparatus 100 may output a projection image 1721 while a vertical inclination exists, and due to the vertical inclination, the projection image 1721 may be output in a trapezoid form but not a rectangular form which is the original image form. For resolving the problem that is generated due to existence of a vertical inclination, the electronic apparatus 100 may perform the keystone function.

Referring to the embodiment 1730, the electronic apparatus 100 may perform the keystone function so that a projection image 1731 that was ultimately output by modifying the original image becomes a rectangular form.

FIG. 18 is a diagram for illustrating an operation of performing a keystone function in consideration of a horizontal inclination.

Referring to the embodiment 1810 in FIG. 18, the electronic apparatus 100 may output a projection image while a horizontal inclination exists.

Referring to the embodiment 1820, the electronic apparatus 100 may output a projection image 1821 while a horizontal inclination exists, and due to the horizontal inclination, the projection image 1821 may be output in a trapezoid form but not a rectangular form which is the original image form. For resolving the problem that is generated due to existence of a horizontal inclination, the electronic apparatus 100 may perform the keystone function.

Referring to the embodiment 1830, the electronic apparatus 100 may perform the keystone function so that a projection image 1831 that was ultimately output by modifying the original image becomes a rectangular form.

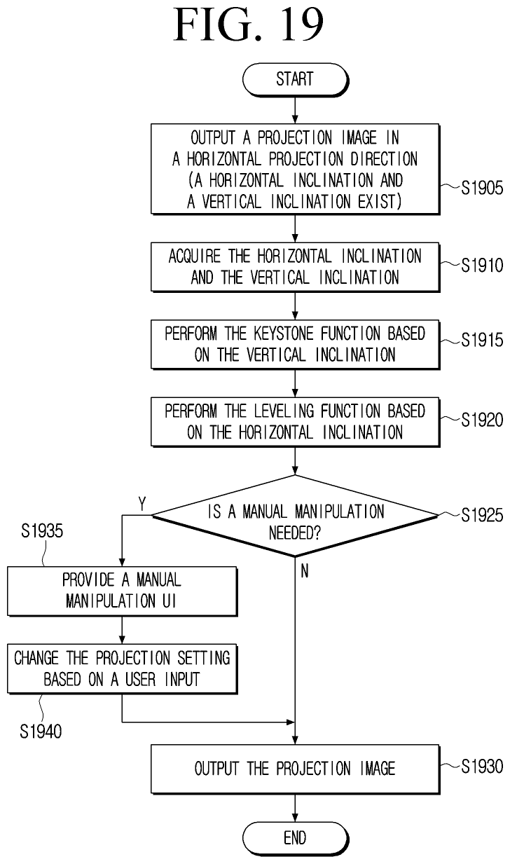

FIG. 19 is a flow chart for illustrating a projecting operation in consideration of a horizontal projection direction according to still another embodiment.

Referring to FIG. 19, the electronic apparatus 100 may output a projection image in a horizontal projection direction while both of a horizontal inclination and a vertical inclination exist in operation S1905. Then, the electronic apparatus 100 may acquire the horizontal inclination and the vertical inclination in operation S1910. Then, the electronic apparatus 100 may perform the keystone function based on the horizontal inclination in operation S1915. Then, the electronic apparatus 100 may perform the keystone function based on the vertical inclination in operation S1920. The order of the operation S1915 and the operation S1920 may be changed depending on implementation examples.

The electronic apparatus 100 may identify whether a manual manipulation is additionally needed after performing the keystone function in operation S1925. For determining whether a manual manipulation is additionally needed, the electronic apparatus 100 may use a user input or a captured image. As an example, if a user input for providing a manual manipulation UI is received, the electronic apparatus 100 may determine that a manual manipulation is additionally needed. As another example, the electronic apparatus 100 may acquire a captured image by capturing a projection image that was output after performing the keystone function. Then, the electronic apparatus 100 may determine whether the captured image was normally corrected. If it is identified that the projection image included in the captured image is not a rectangle, the electronic apparatus 100 may determine that a manual manipulation is additionally needed.

If it is determined that a manual manipulation is not needed in operation S1925-N, the electronic apparatus 100 may directly output the projection image in operation S1930. If it is determined that a manual manipulation is needed in operation S1925-Y, the electronic apparatus 100 may provide a manual manipulation UI in operation S1935. Then, the electronic apparatus 100 may change the projection setting based on a user input received through the manual manipulation UI in operation S1940. Then, the electronic apparatus 100 may output the projection image based on the changed projection setting in operation S1930.

FIG. 20 is a diagram for illustrating an operation of performing a leveling function in consideration of a horizontal distortion.

Referring to the embodiment 2010 in FIG. 20, the electronic apparatus 100 may output a projection image while a horizontal distortion exists.

Referring to the embodiment 2020, the electronic apparatus 100 may output a projection image 2021 while a horizontal distortion exists, and due to the horizontal distortion, the projection image 2021 may be output in a state of having rotated in the horizontal direction. For resolving the problem that is generated due to existence of a horizontal distortion, the electronic apparatus 100 may perform the leveling function.

Referring to the embodiment 2030, the electronic apparatus 100 may perform the leveling function so that a rotated projection image 2031 is output.

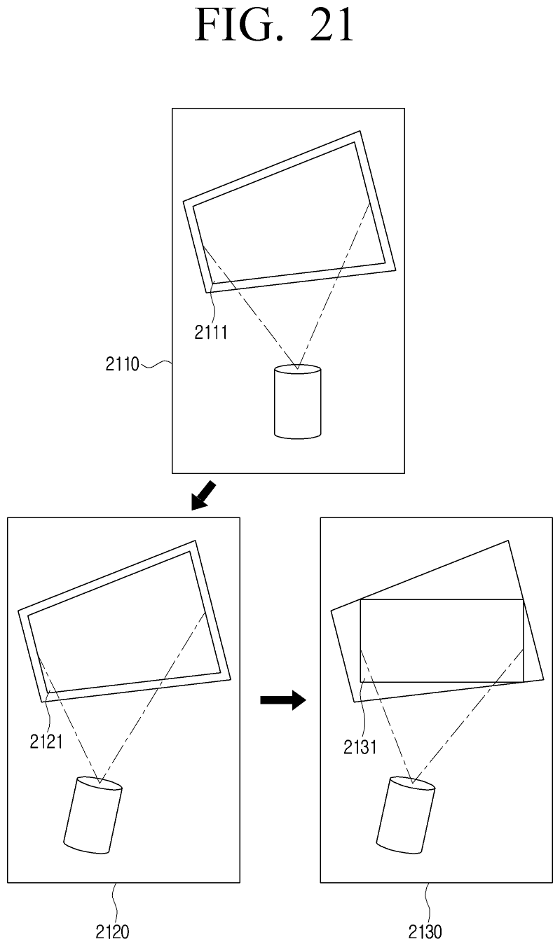

FIG. 21 is a diagram for illustrating operations of performing a keystone function and a leveling function.

Referring to the embodiment 2110 in FIG. 21, the electronic apparatus 100 may output a projection image 2111 while a horizontal inclination and a horizontal distortion exist. Due to the horizontal inclination, the projection image 2111 may be output in a trapezoid form. For resolving the problem that is generated due to existence of the horizontal inclination, the electronic apparatus 100 may perform the keystone function.

Referring to the embodiment 2120, the electronic apparatus 100 may perform the keystone function so that a projection image 2121 that was ultimately output by modifying the original image becomes a rectangular form. However, as the horizontal distortion still exists, the projection image 2121 in a rectangular form may be output in a state of having rotated in the horizontal direction. For resolving the problem that is generated due to existence of the horizontal distortion, the electronic apparatus 100 may perform the leveling function.

Referring to the embodiment 2130, the electronic apparatus 100 may perform the leveling function so that the rotated projection image 2131 is output.

As a result, the electronic apparatus 100 may perform both of the keystone function and the leveling function, and provide an image in a rectangular form that is not inclined to the user.

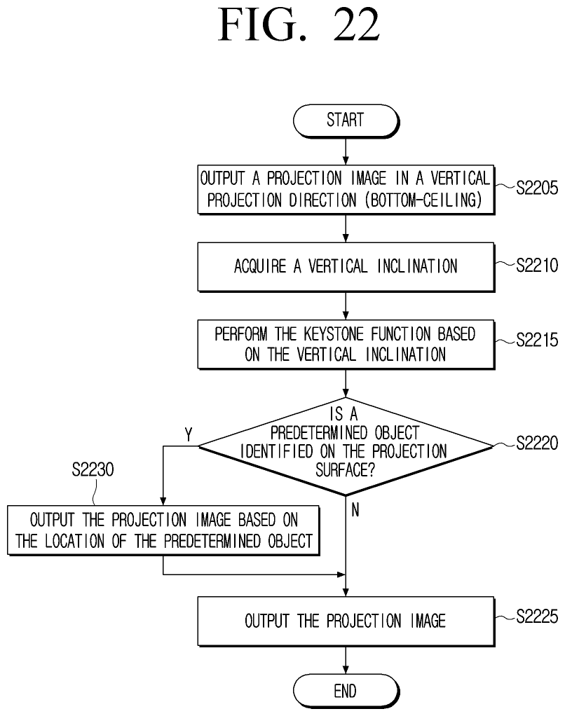

FIG. 22 is a flow chart for illustrating a projecting operation in consideration of a vertical projection direction according to an embodiment.

Referring to FIG. 22, the electronic apparatus 100 may output a projection image in a vertical projection direction toward the ceiling from the bottom in operation S2205. Then, the electronic apparatus 100 may acquire a vertical inclination in operation S2210. Then, the electronic apparatus 100 may perform the keystone function based on the vertical inclination in operation S2215.

The electronic apparatus 100 may determine whether a predetermined object is identified on the projection surface in operation S2220. If the predetermined object is not identified on the projection surface in operation S2220-N, the electronic apparatus 100 may directly output the projection image in operation S2225.

If the predetermined object is identified on the projection surface in operation S2220-Y, the electronic apparatus 100 may output the projection image based on the location of the predetermined object in operation S2230. Here, the meaning of the operation of considering the location of the predetermined object may mean an operation of outputting the projection image while evading the predetermined object, or an operation of making the predetermined object and the output location of the projection image coincide.

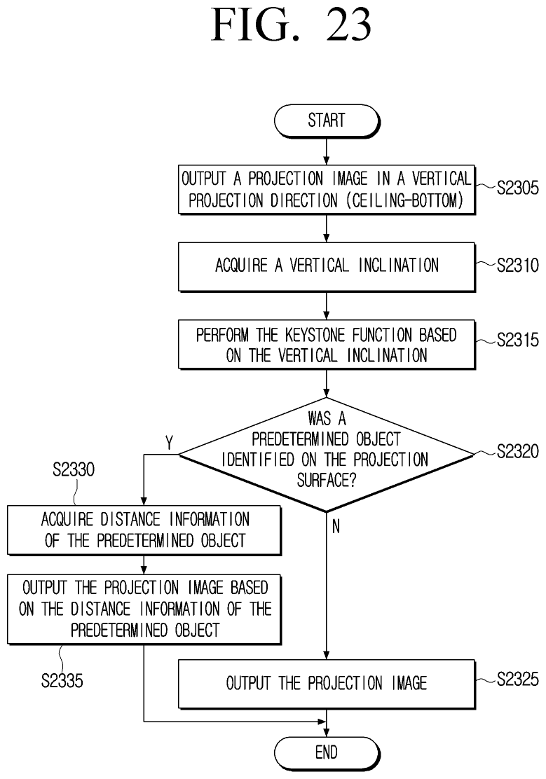

FIG. 23 is a flow chart for illustrating a projecting operation in consideration of a vertical projection direction according to another embodiment.

Referring to FIG. 23, the electronic apparatus 100 may output a projection image in a vertical projection direction toward the bottom from the ceiling in operation S2305. Then, the electronic apparatus 100 may acquire a vertical inclination in operation S2310. Then, the electronic apparatus 100 may perform the keystone function based on the vertical inclination in operation S2315.

The electronic apparatus 100 may determine whether a predetermined object is identified on the projection surface in operation S2320. If the predetermined object is not identified on the projection surface in operation S2320-N, the electronic apparatus 100 may directly output the projection image in operation S2325.

If the predetermined object is identified on the projection surface in operation S2320-Y, the electronic apparatus 100 may acquire the distance information between the predetermined object and the electronic apparatus 100 in operation S2330. Then, the electronic apparatus 100 may output the projection image based on the distance information between the predetermined object and the electronic apparatus 100 in operation S2335.

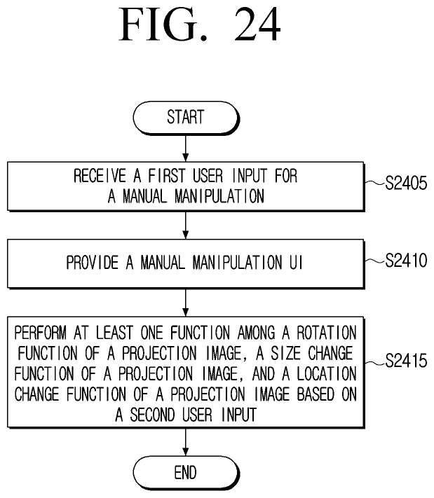

FIG. 24 is a flow chart for illustrating an operation of providing a manual manipulation UI.

Referring to FIG. 24, the electronic apparatus 100 may receive a first user input for a manual manipulation in operation S2405. Then, the electronic apparatus 100 may provide a manual manipulation UI based on the first user input in operation S2410. Then, the electronic apparatus 100 may perform at least one function among a rotation function of a projection image, a size change function of a projection image, and a location change function of a projection image based on a second user input in operation S2415.

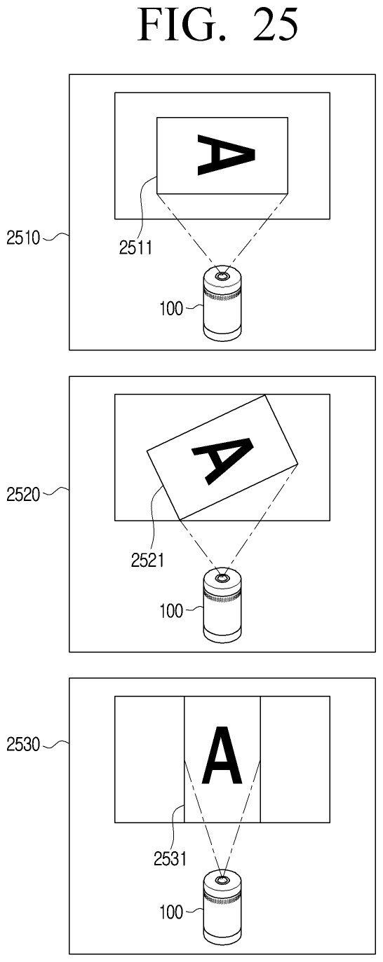

FIG. 25 is a diagram for illustrating a rotating function of a projection image.

Referring to the embodiment 2510 in FIG. 25, the electronic apparatus 100 may output a projection image 2511 that is not appropriate for the user even after at least one function from among the keystone function and the leveling function was performed. Due to a problem other than a horizontal inclination, a vertical inclination, and a horizontal distortion, a projection image not selected desired by the user may be output.

As an example, a rotating direction of a projection image may not be a direction selected by the user. Accordingly, the electronic apparatus 100 may output the projection image by rotating it.

Referring to the embodiment 2520, the electronic apparatus 100 may output a projection image 2521 in a state of having rotated the projection image 2511 in the embodiment 2510 as much as 45 degrees in a counter-clockwise direction.

Also, referring to the embodiment 2530, the electronic apparatus 100 may output a projection image 2531 in a state of having rotated the projection image 2521 in the embodiment 2520 as much as 45 degrees in a counter-clockwise direction.

That is, the electronic apparatus 100 may rotate a projection image at an interval of 45 degrees. Depending on another implementation example, the electronic apparatus 100 may rotate a projection image at an interval of 90 degrees. If a projection image is rotated at an interval of 90 degrees, the projection image 2511 in the embodiment 2510 may directly be rotated to the projection image 2531 in the embodiment 2530.

An interval of a projection image may be determined according to the user's setting.

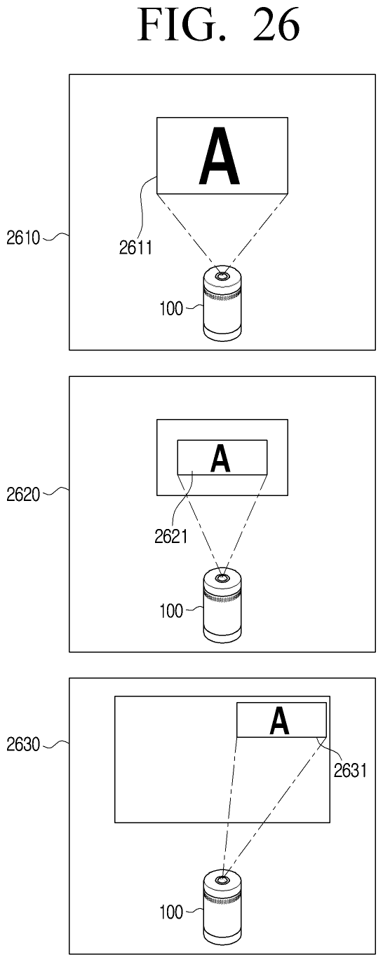

FIG. 26 is a diagram for illustrating a size change function and a location change function of a projection image.

Referring to the embodiment 2610 in FIG. 26, the electronic apparatus 100 may output a projection image 2611 onto a projection surface. The electronic apparatus 100 may change the size of the projection image based on a user input or a predetermined event. The predetermined event may mean an event wherein a predetermined object is identified. The electronic apparatus 100 may change the size of the projection image based on the location of the predetermined object.

Referring to the embodiment 2620, the electronic apparatus 100 may output a projection image 2621 by changing the size of the projection image 2611 in the embodiment 2610. Also, the electronic apparatus 100 may change the projection location of the projection image based on a user input or a predetermined event. The predetermined event may mean an event in which a predetermined object is identified. The electronic apparatus 100 may change the size of the projection image based on the location of the predetermined object.

Referring to the embodiment 2630, the electronic apparatus 100 may change the location wherein the projection image 2621 in the embodiment 2620 is output. The electronic apparatus 100 may output a projection image 2631 based on the changed location.

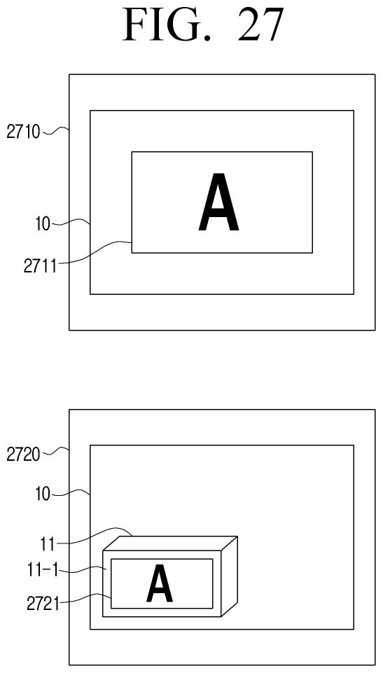

FIG. 27 is a diagram for illustrating an operation of specifying a projection area.

Referring to the embodiment 2710 in FIG. 27, the electronic apparatus 100 may output a projection image 2711 onto a projection surface 10. The embodiment 2710 may be a situation wherein a projection image is output in a general situation.

Referring to the embodiment 2720, the electronic apparatus 100 may identify a predetermined object 11 on the projection surface 10. The predetermined object 11 may mean an object that is used in outputting a projection image. The electronic apparatus 100 may acquire the location of the predetermined object 11, and acquire a projection area 11-1 wherein the projection image can be output on the predetermined object 11. Then, the electronic apparatus 100 may output a projection image 2721 in the projection area 11-1. The projection image 2721 may be an image which is the original projection image 2711 of which size has been changed, and may be an image of which projection location has been changed.

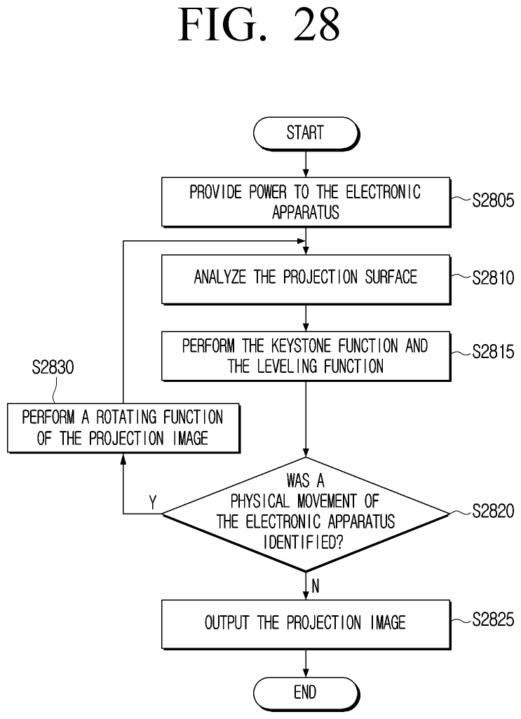

FIG. 28 is a flow chart for illustrating an operation that is performed in case a state of the electronic apparatus 100 is changed.

Referring to FIG. 28, power may be supplied to the electronic apparatus 100 in operation S2805. The state in which power has been supplied may be described as a power supply state or a normal operation state. The electronic apparatus 100 may analyze a projection surface in operation S2810. Then, the electronic apparatus 100 may perform the keystone function and the leveling function in operation S2815.

The electronic apparatus 100 may determine whether there is a physical movement in operation S2820. The electronic apparatus 100 may identify whether the location or the rotation of the electronic apparatus 100 is changed by greater than or equal to a threshold value during projection. For example, the electronic apparatus 100 may identify whether the electronic apparatus 100 was moved to another space, or the projection direction of the electronic apparatus 100 was changed. The electronic apparatus 100 may identify whether the physical arrangement has been changed through the acceleration sensor or the gyro sensor, etc.

If a physical movement of the electronic apparatus 100 is not identified in operation S2820-N, the electronic apparatus 100 may output the projection image as it is in operation S2825. If a physical movement of the electronic apparatus 100 is identified in operation S2820-Y, the electronic apparatus 100 may perform a rotating function of the projection image in operation S2830. Then, the electronic apparatus 100 may repeat the operation S2810 of analyzing the projection surface and the operation S2815 of performing the keystone function and the leveling function. Depending on implementation examples, the operation S2830 may be omitted.

FIG. 29 is a flow chart for illustrating an operation that is performed in case a predetermined object is identified on a projection surface according to an embodiment.

Referring to FIG. 29, the electronic apparatus 100 may output a projection image in a horizontal projection direction in operation S2905. Then, the electronic apparatus 100 may acquire a captured image that captured the projection surface in operation S2910. Then, the electronic apparatus 100 may determine whether a line object is identified on the projection surface in operation S2915.

If a line object is not identified in operation S2915-N, the electronic apparatus 100 may output the projection image as it is in operation S2920.

If a line object is identified in operation S2915-Y, the electronic apparatus 100 may output the projection image based on the location of the line object in operation S2925. A specific situation in which the location of the line object is considered will be described in FIG. 30.

FIG. 30 is a diagram for illustrating an operation of outputting a projection image in consideration of a predetermined object.

Referring to the embodiment 3010 in FIG. 30, the electronic apparatus 100 may identify at least one line object 11-1, 11-2, 11-3, 11-4 on a projection surface 10. The electronic apparatus 100 may output a projection image 3011 as it is without considering the line object. In the case of not considering the line object, the projection image 3011 may overlap with the line object, and thus visibility may become bad.

Referring to the embodiment 3020 in FIG. 30, the electronic apparatus 100 may output a projection image 3021 in consideration of the locations of the line objects 11-1, 11-2, 11-3, 11-4. The electronic apparatus 100 may acquire the locations of the line objects 11-1, 11-2, 11-3, 11-4, and change at least one of the size or the output location of the projection image based on the locations of the line objects 11-1, 11-2, 11-3, 11-4. The electronic apparatus 100 may change at least one of the size or the output location of the projection image so that the area wherein the projection image is output does not overlap with the line objects 11-1, 11-2, 11-3, 11-4. The electronic apparatus 100 may output the projection image so that the outer rim portion of the projection image is in parallel with the line objects 11-1, 11-2, 11-3, 11-4. Then, the electronic apparatus 100 may output the projection image so that the outer rim portion of the projection image is output within a threshold distance from the line objects 11-1, 11-2, 11-3, 11-4. The embodiment 3020 may be a situation in which the projection image was output in a state wherein a number close to 0 (e.g., 0.1 cm) was applied as the threshold distance.

The embodiment 3020 in FIG. 30 described an operation of considering all of the identified line objects 11-1, 11-2, 11-3, 11-4. However, depending on implementation examples, a projection image may be changed by considering only some line objects among the plurality of line objects 11-1, 11-2, 11-3, 11-4. For example, the electronic apparatus 100 may change at least one of the size or the output location of the projection image in consideration of only the line objects in the uppermost part and the leftmost (the far left) part.

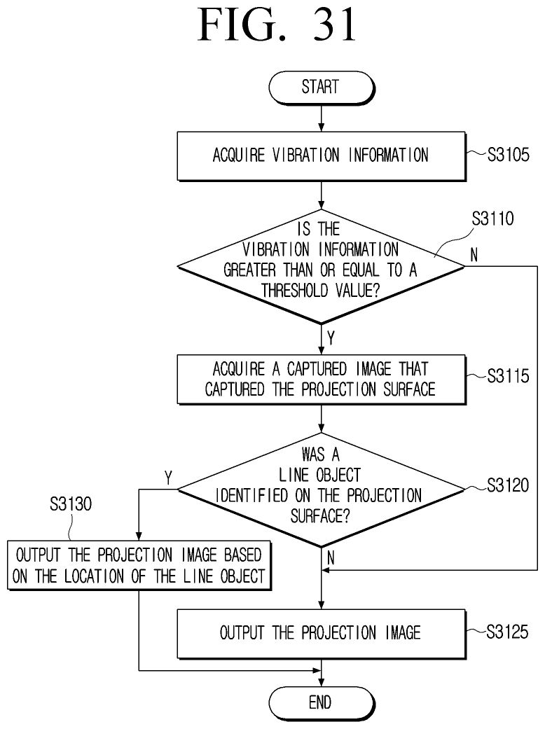

FIG. 31 is a flow chart for illustrating an operation of outputting a projection image in consideration of whether the electronic apparatus 100 vibrates.

Referring to FIG. 31, the electronic apparatus 100 may acquire vibration information in operation S3105. As an example, the electronic apparatus 100 may acquire vibration information through at least one sensor among the vibration sensor, the acceleration sensor, and the gyro sensor. The electronic apparatus 100 may identify whether the vibration information is greater than or equal to a threshold value in operation S3110.

If the vibration information is smaller than the threshold value in operation S3110-N, the electronic apparatus 100 may output a projection image as it is in operation S3125.

If the vibration information is greater than or equal to the threshold value in operation S3110-Y, the electronic apparatus 100 may acquire a captured image that captured the projection surface in operation S3115. Then, the electronic apparatus 100 may identify a line object on the projection surface in operation S3120. If a line object is not identified in operation S3120-N, the electronic apparatus 100 may output the projection image as it is.

If a line object is identified on the projection surface in operation S3120-Y, the electronic apparatus 100 may output the projection image based on the location of the line object in operation S3130.

FIG. 32 is a flow chart for illustrating an operation that is performed in case a predetermined object is identified on a projection surface according to another embodiment.

Referring to FIG. 32, the electronic apparatus 100 may output a projection image in a vertical projection direction toward the ceiling from the bottom in operation S3205. Then, the electronic apparatus 100 may acquire a captured image that captured the projection surface in operation S3210. Then, the electronic apparatus 100 may acquire distance information between the projection surface and the electronic apparatus 100 in operation S3215.

The electronic apparatus 100 may determine whether an edge object is identified on the projection surface in operation S3220. If an edge object is not identified on the projection surface in operation S3220-N, the electronic apparatus 100 may output a projection image by using only the distance information of the projection surface in operation S3225. If an edge object is identified on the projection surface in operation S3220-Y, the electronic apparatus 100 may output the projection image based on the distance information of the projection surface and the location of the edge object in operation S3230.

FIG. 33 is a diagram for illustrating an operation of outputting a projection image in consideration of an edge part of a wall.

Referring to FIG. 33, the electronic apparatus 100 may identify a first projection surface 10-1 and a second projection surface 10-2. Then, the electronic apparatus 100 may identify an edge object 11 between the first projection surface 10-1 and the second projection surface 10-2. The edge object 11 may mean a boundary line of an adjacent wall surface.

If the edge object 11 is identified, the electronic apparatus 100 may output a projection image 3301 based on the location of the edge object. The electronic apparatus 100 may output the projection image 3301 in a location distanced from the location of the edge object 11 by a threshold distance. Also, the electronic apparatus 100 may perform control so that the edge object 11 and the projection image 3301 do not overlap. Specifically, the electronic apparatus 100 may output the projection image 3301 on any one wall surface from among the first projection surface 10-1 and the second projection surface 10-2 divided based on the edge object 11.

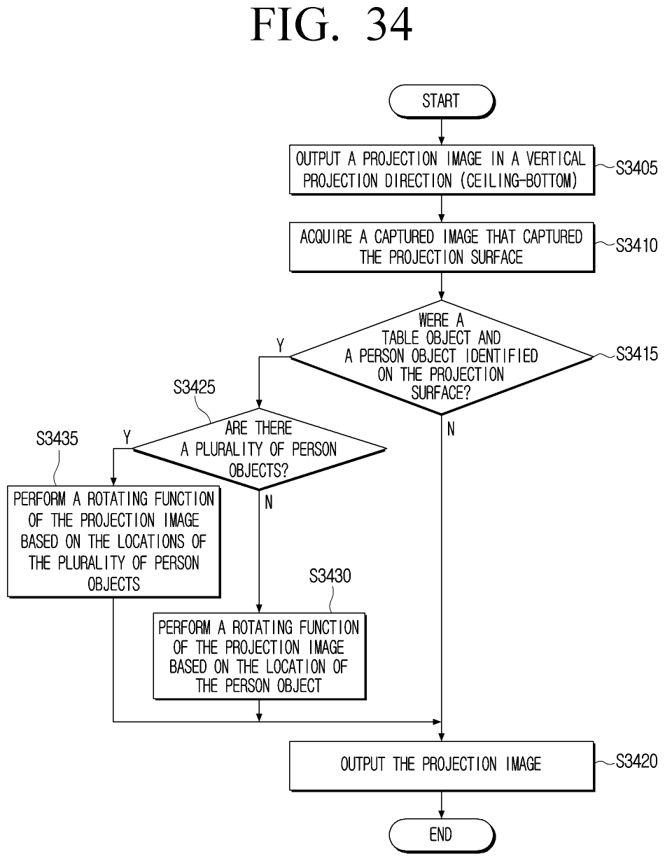

FIG. 34 is a flow chart for illustrating an operation that is performed in case a predetermined object is identified on a projection surface according to still another embodiment.

Referring to FIG. 34, the electronic apparatus 100 may output a projection image in a vertical projection direction toward the bottom from the ceiling in operation S3405. Then, the electronic apparatus 100 may acquire a captured image that captured the projection surface in operation S3410.

The electronic apparatus 100 may determine whether both of a table object and a person object are identified on the projection surface in operation S3415. In case both of a table object and a person object are not identified on the projection surface in operation S3415-N, the electronic apparatus 100 may output the projection image as it is in operation S3420. In case at least one object from among a table object and a person object is not identified, the electronic apparatus 100 may output the projection image as it is without a separate additional operation. The operation of identifying a table object may mean using the table as the projection surface.

In case both of a table object and a person object are identified on the projection surface in operation S3415-Y, the electronic apparatus 100 may identify whether there are a plurality of person objects in operation S3425. In case there are not a plurality of person objects in operation S3425-N, the electronic apparatus 100 may perform a rotating function of the projection image based on the location of the person object in operation S3430. Then, the electronic apparatus 100 may output the projection image in operation S3420.

In case there are a plurality of person objects in operation S3425-Y, the electronic apparatus 100 may perform a rotating function of the projection image based on the locations of the plurality of person objects in operation S3435. Then, the electronic apparatus 100 may output the projection image in operation S3420.

The processor 114 may identify a gaze direction of a person object. The gaze direction may mean direction information indicating where the person is viewing. The processor 114 may identify the gaze direction of the person object by recognizing a face object corresponding to the person object. The gaze direction may not necessarily mean information indicating where the person is actually viewing, but may mean information indicating in which direction the person may view.

The processor 114 may perform a rotating function of a projection image based on the gaze direction of the person object. The rotating function may mean a function of controlling in which direction the projection image is output. The rotating function may mean an operation for determining the projection direction.

According to an embodiment, in case the gaze directions of a plurality of person objects are the same as the first direction, the processor 114 may output a projection image in a first direction.

According to an embodiment, in case the gaze directions of a plurality of person objects are different as a first direction and a second direction, the processor 114 may output a projection image in an average direction of the first direction and the second direction.

As an example, in case a first person object and a second person object face each other (in case the angle between the first gaze direction and the second gaze direction is 180 degrees), the processor 114 may output a projection image by rotating the image from the first gaze direction by 90 degrees in a counter-clockwise direction. The output projection image may be an image that was output while being rotated in a clockwise direction based on the second gaze direction by 90 degrees.

As another example, in case the first person object and the second person object are located obliquely (in case the angle between the first gaze direction and the second gaze direction is 90 degrees), the processor 114 may output a projection image in a middle direction between the first gaze direction and the second gaze direction. The processor 114 may output the projection image by rotating the image from the first gaze direction to the second gaze direction by 45 degrees. The output projection image may be a projection image that was output while being rotated to the first gaze direction based on the second gaze direction by 45 degrees.

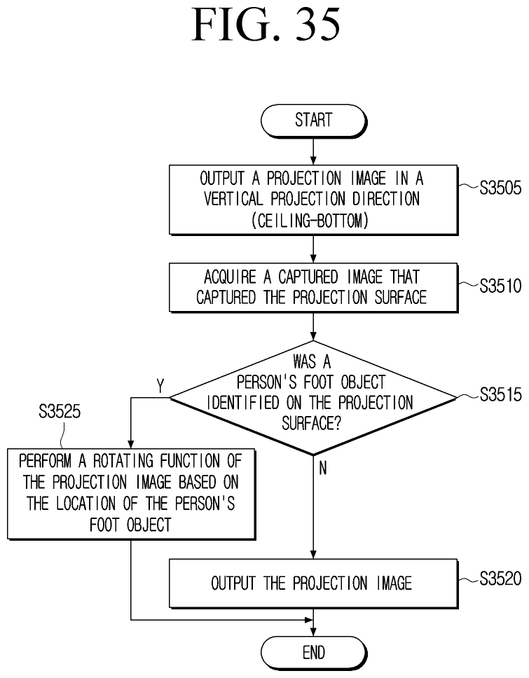

FIG. 35 is a flow chart for illustrating an operation that is performed in case a predetermined object is identified on a projection surface according to still another embodiment.

Referring to FIG. 35, the electronic apparatus 100 may output a projection image in a vertical projection direction toward the bottom from the ceiling in operation S3505. Then, the electronic apparatus 100 may acquire a captured image that captured the projection surface in operation S3510.

The electronic apparatus 100 may determine whether a person's foot object is identified on the projection surface in operation S3515. If a person's foot object is not identified in operation S3515-N, the electronic apparatus 100 may output the projection image as it is in operation S3520.

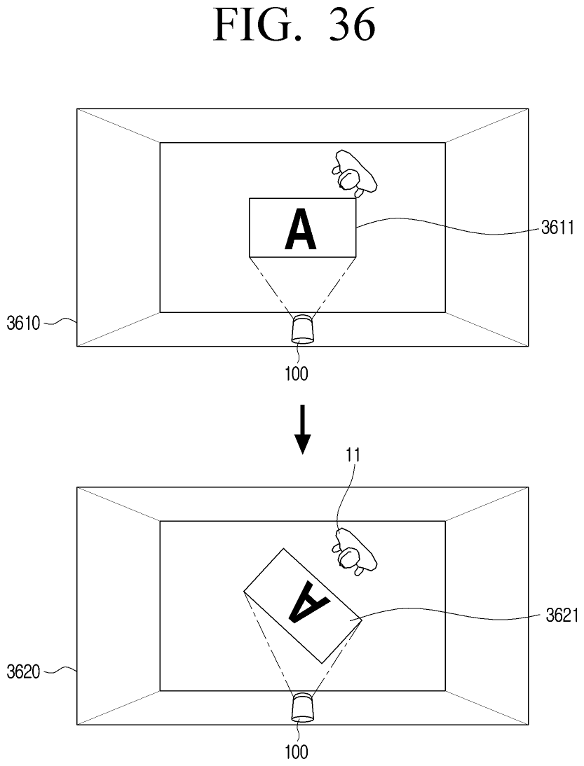

If a person's foot object is identified in operation S3515-Y, the electronic apparatus 100 may perform a rotating function of the projection image based on the location of the person's foot object in operation S3525. A detailed example will be described in FIG. 36.

FIG. 36 is a diagram for illustrating an operation of outputting a projection image in consideration of a foot object of a user.

Referring to the embodiment 3610 in FIG. 36, the electronic apparatus 100 may output a projection image 3611 in a general situation.

Referring to the embodiment 3620, the electronic apparatus 100 may identify the user's foot object 11. If the user's foot object 11 is identified, the electronic apparatus 100 may perform control to rotate the projection image based on the direction and the location of the user's foot object. The direction of the foot object may be used in identifying toward where the user is standing. The location of the foot object may be used in specifying the projection area.

The electronic apparatus 100 may rotate the projection image based on the direction of the foot object, and determine the projection area based on the location of the foot object. Then, the electronic apparatus 100 may ultimately output a projection image 3621 to suit the direction wherein the user is standing.

Compared to the embodiment 3610, in the embodiment 3620, a projection image fit for a direction wherein the user is standing may be output, and thus a projection image appropriate for the user can be provided.

FIG. 37 is a flow chart for illustrating an operation of outputting a projection image in consideration of location information of an external apparatus.

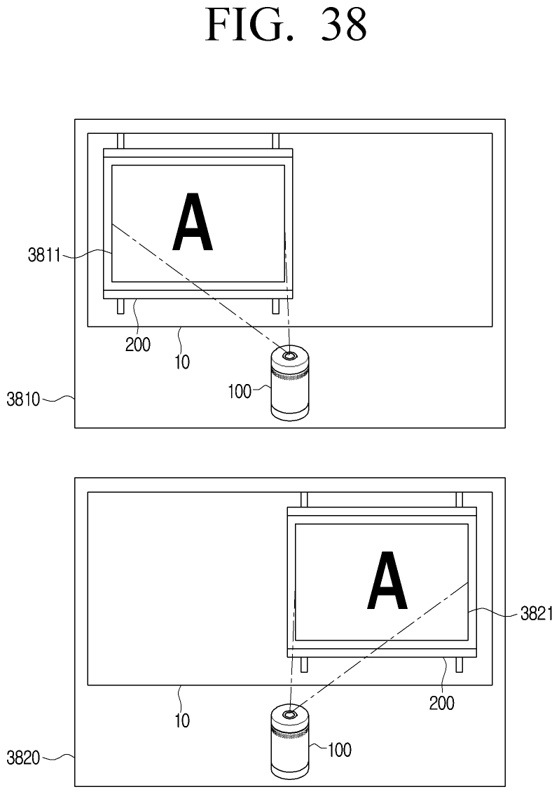

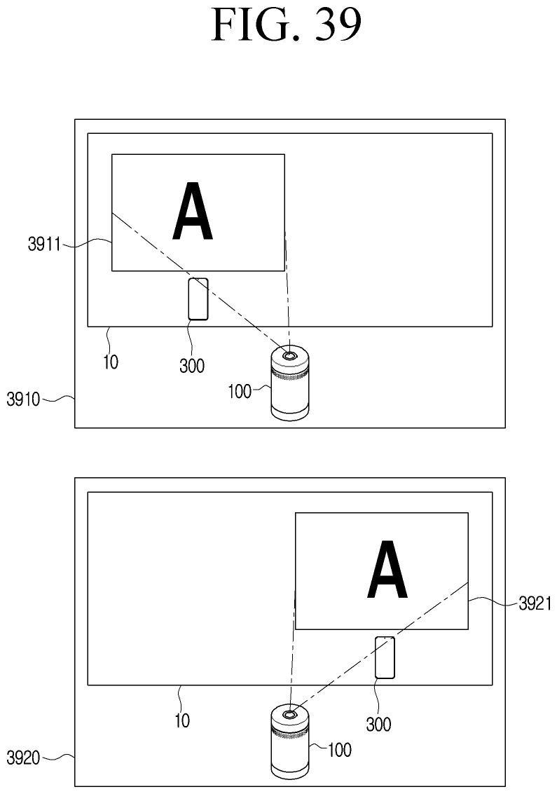

Referring to FIG. 37, the electronic apparatus 100 may identify an external apparatus in which communicative connection is performed in operation S3705. If an external apparatus in which communicative connection is performed is not identified in operation S3705-N, the electronic apparatus 100 may repeatedly identify an external apparatus wherein communicative connection is performed. The external apparatus may be a portable screen that can communicate with the electronic apparatus 100 or a portable terminal apparatus for directing a projection area. Explanation related to a portable screen will be described in FIG. 38. Explanation related to a portable terminal apparatus will be described in FIG. 39.

If an external apparatus in which communicative connection is performed is identified in operation S3705-Y, the electronic apparatus 100 may acquire location information of the external apparatus in operation S3710. Then, the electronic apparatus 100 may output a projection image based on the location information of the external apparatus.

FIG. 38 is a diagram for illustrating an operation of outputting a projection image in consideration of location information of a screen according to an embodiment.

Referring to the embodiment 3810 in FIG. 38, the electronic apparatus 100 may perform communication with a portable screen 200 which is an external apparatus. The electronic apparatus 100 may acquire location information of the portable screen 200. The electronic apparatus 100 may identify a projection area 3811 in the entire area of a projection surface 10 based on the location information of the portable screen 200. The electronic apparatus 100 may output a projection image in the identified projection area 3811. The electronic apparatus 100 may store the size information of the portable screen 200 in advance. Accordingly, the electronic apparatus 100 may receive the location information of the portable screen 200 in real time, and identify the size of the projection image and the projection area in which the projection image is projected based on the location and the size of the portable screen 200.

Referring to the embodiment 3820, in case the location of the portable screen 200 is changed or the location of the projection surface 10 is changed, the electronic apparatus 100 may regularly identify an appropriate projection area 3821.

FIG. 39 is a diagram for illustrating an operation of outputting a projection image in consideration of location information of a mobile apparatus according to an embodiment.

Referring to the embodiment 3910 in FIG. 39, the electronic apparatus 100 may perform communication with a portable terminal apparatus 300 which is an external apparatus. The electronic apparatus 100 may acquire the location information of the portable terminal apparatus 300. The electronic apparatus 100 may identify a projection area 3911 in the entire area of the projection surface 10 based on the location information of the portable terminal apparatus 300. The electronic apparatus 100 may output a projection image in the identified projection area 3911.

Referring to the embodiment 3920, in case the location of the portable terminal apparatus 300 is changed or the location of the projection surface 10 is changed, the electronic apparatus 100 may regularly identify an appropriate projection area 3921.

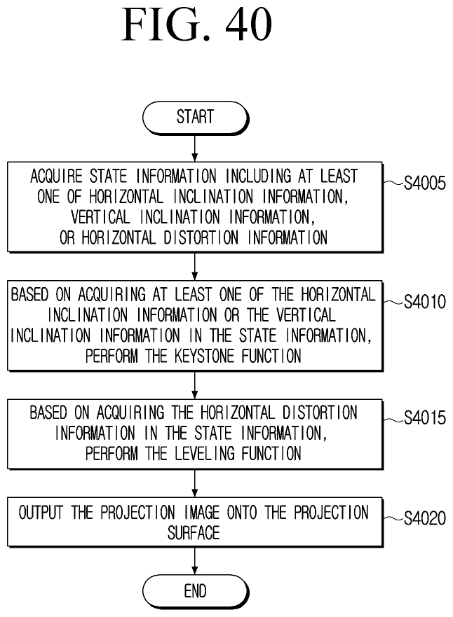

FIG. 40 is a flow chart for illustrating a controlling method of the electronic apparatus 100 according to an embodiment of the disclosure.

Referring to FIG. 40, a controlling method of the electronic apparatus 100 according to an embodiment of the disclosure includes the steps of acquiring state information including at least one of horizontal inclination information, vertical inclination information, or horizontal distortion information (S4005), based on acquiring at least one of the horizontal inclination information or the vertical inclination information in the state information, performing a keystone function (S4010), based on acquiring the horizontal distortion information in the state information, performing a leveling function (S4015), and outputting a projection image onto a projection surface (S4020).

The controlling method may further include the steps of acquiring information related to the projection surface, identifying the sizes of a projection area in which a projection image is output and the projection image based on the information related to the projection surface, and outputting the projection image in the projection area based on the size of the projection image, where the information related to the projection surface may include at least one of pattern information of the projection surface, color information of the projection surface, or distance information between the projection surface and the electronic apparatus 100.

The controlling method may further include the step of, based on identifying a predetermined object, outputting the projection image in consideration of the location of the predetermined object.

The predetermined object may be a line object, and the step of outputting the projection image may further include the step of, based on identifying the line object, outputting the projection image so that the line object and the outer rim portion of the projection image are in parallel.

The predetermined object may be an edge object, and the step of outputting the projection image may further include the step of outputting a projection image onto one projection surface among a plurality of projection surfaces divided by the edge object.

The controlling method may further include the steps of, based on acquiring vibration information greater than or equal to a threshold value, acquiring a captured image through the camera, and identifying the predetermined object based on the captured image.

The controlling method may further include the step of, based on identifying a predetermined event, providing a user interface (UI) for providing at least one function among a rotation function of a projection image, a size change function of a projection image, and a location change function of a projection image.

The controlling method may further include the step of, after performing at least one of the keystone function or the leveling function based on the state information, based on acquiring movement information greater than or equal to a threshold value of the electronic apparatus 100, performing at least one of the keystone function or the leveling function again.

The controlling method may further include the steps of acquiring location information of external apparatuses 200, 300 communicating with the electronic apparatus 100, and identifying a projection area in which the projection image is output based on the location information of the external apparatuses 200, 300.

The controlling method may further include the step of, based on the location information of the external apparatuses 200, 300 being changed, changing the projection area in which the projection image is output based on the changed location information.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic apparatus comprising:
a projection unit;
a sensor assembly; and
a processor configured to:
acquire state information including at least one of horizontal inclination information, vertical inclination information, or horizontal distortion information based on sensing data acquired through the sensor assembly,
based on acquiring at least one of the horizontal inclination information or the vertical inclination information in the state information, perform a keystone function,
based on acquiring the horizontal distortion information in the state information, perform a leveling function, and
control the projection unit to output a projection image onto a projection surface.

2. The electronic apparatus of claim 1,
wherein the processor is further configured to:
acquire information based on the projection surface,
identify a size of a projection area in which the projection image is output and a size of the projection image based on the information based on the projection surface, and
control the projection unit to output the projection image in the projection area based on the size of the projection image, and
wherein the information based on the projection surface comprises:
at least one of pattern information of the projection surface, color information of the projection surface, or distance information between the projection surface and the electronic apparatus.

3. The electronic apparatus of claim 1,
wherein the processor is further configured to:
based on identifying a predetermined object, control the projection unit to output the projection image depending on a location of the predetermined object.

4. The electronic apparatus of claim 3,
wherein the predetermined object comprises a line object, and
wherein the processor is further configured to:
based on identifying the line object, control the projection unit such that the line object and an outer rim portion of the projection image are in parallel.

5. The electronic apparatus of claim 3,
wherein the predetermined object comprises an edge object, and
wherein the processor is further configured to:
control the projection unit to output the projection image onto a first projection surface among a plurality of projection surfaces divided by the edge object.

6. The electronic apparatus of claim 3, further comprising:
a camera,
wherein the processor is further configured to:
based on acquiring vibration information greater than or equal to a threshold value based on the sensing data of the sensor assembly, acquire a captured image through the camera, and
identify the predetermined object based on the captured image.

7. The electronic apparatus of claim 1,
wherein the processor is further configured to:
based on identifying a predetermined event, provide a user interface (UI) for providing at least one function of a rotation function of a projection image, a size change function of a projection image, or a location change function of a projection image.

8. The electronic apparatus of claim 1,
wherein the processor is further configured to:
after performing at least one of the keystone function or the leveling function based on the state information, and based on acquiring movement information greater than or equal to a threshold value based on the sensing data of the sensor assembly, perform at least one of the keystone function or the leveling function.

9. The electronic apparatus of claim 1, further comprising:
a communication interface configured to communicate with an external apparatus,
wherein the processor is further configured to:
acquire location information of the external apparatus, and
identify a projection area in which the projection image is output based on the location information of the external apparatus.

10. The electronic apparatus of claim 9,
wherein the processor is further configured to:
based on a change of the location information of the external apparatus, change the projection area in which the projection image is output.

11. A method of controlling an electronic apparatus, the method comprising:
acquiring state information including at least one of horizontal inclination information, vertical inclination information, or horizontal distortion information;
based on acquiring at least one of the horizontal inclination information or the vertical inclination information in the state information, performing a keystone function;
based on acquiring the horizontal distortion information in the state information, performing a leveling function; and
outputting a projection image onto a projection surface.

12. The method of claim 11, further comprising:
acquiring information based on the projection surface;
identifying a size of a projection area in which the projection image is output and a size of the projection image based on the information based on the projection surface; and
outputting the projection image in the projection area based on the size of the projection image,
wherein the information based on the projection surface comprises:
at least one of pattern information of the projection surface, color information of the projection surface, or distance information between the projection surface and the electronic apparatus.

13. The method of claim 11, further comprising:
based on identifying a predetermined object, outputting the projection image depending on a location of the predetermined object.

14. The method of claim 13,
wherein the predetermined object comprises a line object, and
wherein the outputting the projection image comprises:
based on identifying the line object, outputting the projection image such that the line object and an outer rim of the projection image are in parallel.

15. The method of claim 13,
wherein the predetermined object comprises an edge object, and
wherein the outputting the projection image comprises:
outputting the projection image onto a first projection surface among a plurality of projection surfaces divided by the edge object.
